(19) United States
(12) Patent Application Publication
(10) Pub. No.: US 2021/0031746 A1
(43) Pub. Date: Feb. 4, 2021

(54) CONTROL DEVICE FOR HYBRID VEHICLE

(71) Applicant: TOYOTA JIDOSHA KABUSHIKI KAISHA, Toyota-shi (JP)

(72) Inventors: Atsushi TABATA, Okazaki-shi (JP); Koichi OKUDA, Toyota-shi (JP); Tooru MATSUBARA, Toyota-shi (JP); Yasuhiro HIASA, Miyoshi-shi (JP); Yasutaka TSUCHIDA, Toyota-shi (JP)

(73) Assignee: TOYOTA JIDOSHA KABUSHIKI KAISHA, Toyota-shi (JP)

(21) Appl. No.: 16/925,204

(22) Filed: Jul. 9, 2020

(30) Foreign Application Priority Data
Aug. 2, 2019 (JP) 2019-143333

(51) Int. Cl. B60W 20/15; B60W 10/06; B60W 10/08; B60W 10/10; B60W 10/12; F02N 11/08; F02D 41/06

(52) U.S. Cl. CPC B60W 20/15; B60W 10/06; B60W 10/08; F02D 41/062; B60W 10/12; F02N 11/08; B60W 10/10

(57) ABSTRACT

When an engine during rotation stop is started, a target cranking speed is set to a value at which a first rotating machine MG1 is maintained in an electric power generation state when a request engine power is an output that needs a turbocharging pressure and which is higher than when the request output is not the output that needs the turbocharging pressure, and even after the engine is brought into the operating state, an MG1 cranking torque is controlled to apply a torque for increasing an engine speed of the engine to the target cranking speed to the engine. In this way, it is possible to increase the engine speed after an autonomous operation more quickly while suppressing power consumption of the first rotating machine MG1.

### CROSS-REFERENCE TO RELATED APPLICATION

This application claims priority to Japanese Patent Application No. 2019-143333 filed on Aug. 2, 2019, incorporated herein by reference in its entirety.

### BACKGROUND

### 1. Technical Field

The disclosure relates to a control device for a hybrid vehicle including an engine with a turbocharger and a rotating machine.

### 2. Description of Related Art

A control device for a hybrid vehicle including an engine with a turbocharger, a first rotating machine, an electric transmission mechanism, and a second rotating machine has been well known, where the electric transmission mechanism has a differential mechanism splitting the power of the engine to transmit the split power to drive wheels and the first rotating machine and controls a differential state of the differential mechanism by controlling an operating state of the first rotating machine, and the second rotating machine is connected to the drive wheels to transmit power. For example, the above hybrid vehicle is disclosed in Japanese Unexamined Patent Application Publication No. 2008-222033 (JP 2008-222033 A). JP 2008-222033 A discloses that when an engine start request is made, in a case where a request output in the engine is such a high output to need turbocharging pressure, the engine start is performed by setting the engine speed of the engine to be higher than the engine speed set when the request output is generated, thereby suppressing an output decrease of the engine caused by insufficient turbocharging pressure, that is, delay in rising response of turbocharging pressure.

### SUMMARY

When an engine start request is made, the output torque of the first rotating machine is controlled to apply torque for increasing the engine speed to the engine, that is, the engine is cranked using the first rotating machine. As disclosed in JP 2008-222033 A, when the target engine speed at the time of starting is set to a high value, the engine speed is increased to a high engine speed by the first rotating machine. Then, the power consumption of the first rotating machine may increase, and the energy efficiency of the vehicle may deteriorate.

The disclosure has been made in view of the above circumstances, and an object of the disclosure is to provide a control device for a hybrid vehicle capable of improving a rising response of turbocharging pressure while suppressing deterioration of energy efficiency of a vehicle at the time of starting the engine.

One aspect of the disclosure relates to a control device for a hybrid vehicle. (a) The hybrid vehicle includes an engine with a turbocharger, a first rotating machine, an electric transmission mechanism, and a second rotating machine. The electric transmission mechanism has a differential mechanism splitting power of the engine to transmit the split power to drive wheels and the first rotating machine and controls a differential state of the differential mechanism by controlling an operating state of the first rotating machine, and the second rotating machine is connected to the drive wheels to transmit power. (b) The control device includes an engine start controller configured to control an output torque of the first rotating machine to apply a torque for increasing an engine speed of the engine to the engine and bring the engine into an operating state, when the engine during rotation stop is started. (c) The engine start controller is configured to, when the engine is started, set a target engine speed at a time of increasing the engine speed by the first rotating machine to a value at which the first rotating machine is maintained in an electric power generation state when a request output for the engine is an output that needs a turbocharging pressure by the turbocharger, the value is higher than when the request output is not the output that needs the turbocharging pressure, and even after the engine is brought into the operating state, control the output torque of the first rotating machine to apply a torque for increasing the engine speed to the target engine speed to the engine.

The control device according to the aspect of the disclosure may further includes a torque assist controller configured to output a part of a drive torque from the second rotating machine by using electric power generated by the first rotating machine in the electric power generation state, when the engine is started where the engine speed is increased by the first rotating machine.

In the control device according to the aspect of the disclosure, the engine start controller may be configured to set the target engine speed at the time of increasing the engine speed by the first rotating machine to a predetermined engine speed at which fuel supply to the engine is started to start operation of the engine, when the request output is not the output that needs the turbocharging pressure.

In the control device according to the aspect of the disclosure, the differential mechanism may include a first rotating element to which the engine is connected to transmit power, a second rotating element to which the first rotating machine is connected to transmit power, and a third rotating element that is connected to the drive wheels to transmit power, and the second rotating element, the first rotating element, and the third rotating element may be arranged in order from a first end toward a second end on an alignment chart that relatively represents rotation speeds of respective rotating elements, the engine start controller may be configured to, when the engine is started, apply the torque for increasing the engine speed to the engine by applying, to the engine, a torque for rotating the engine in a positive rotation direction that is a rotation direction when the engine is in the operating state, and the engine start controller may be configured to, when the engine is started, control the output torque of the first rotating machine in the electric power generation state of the first rotating machine by controlling the output torque of the first rotating machine in a state where the first rotating machine is in a negative rotation.

In the control device according to the aspect of the disclosure, the engine start controller may be configured to, when the engine is started, set the target engine speed to be a higher value as a vehicle speed increases, when the request output for the engine is the output that needs the turbocharging pressure.

In the control device according to the aspect of the disclosure, the hybrid vehicle may further include a mechanical transmission mechanism constituting a part of a power transmission path between the electric transmission mechanism and the drive wheels, and the control device may further include a shift controller configured to, when the engine is started where the engine speed is increased by the first rotating machine, downshift the mechanical transmission mechanism when the request output for the engine is the output that needs the turbocharging pressure.

With the control device according to the aspect of the disclosure, when the engine during the rotation stop is started, the target engine speed at the time of increasing the engine speed by the first rotating machine is set to a value at which a first rotating machine is maintained in the electric power generation state when the request output for the engine is the output that needs a turbocharging pressure, and which is higher than when the request output for the engine is not the output that needs the turbocharging pressure, and even after the engine is brought into the operating state, the output torque of the first rotating machine is controlled to apply, to the engine, a torque for increasing an engine speed of the engine to the target engine speed. In this way, it is possible to increase the engine speed after an autonomous operation more quickly while suppressing power consumption of the first rotating machine. Therefore, when the engine is started, it is possible to improve the rising response of the turbocharging pressure while suppressing the deterioration of energy efficiency in the vehicle.

With the control device according to the aspect of the disclosure, some of a drive torque from the second rotating machine is output by using electric power generated by the first rotating machine in the electric power generation state, when the engine is started where the engine speed is increased by the first rotating machine. In this way, it is possible to suppress the deterioration of acceleration response due to the delay in the rising response of turbocharging pressure.

With the control device according to the aspect of the disclosure, the target engine speed at the time of increasing the engine speed by the first rotating machine is set to a predetermined engine speed at which fuel supply to the engine is started to start operation of the engine, when the request output is not the output that needs the turbocharging pressure. In this way, it is possible to bring the engine into the operating state by appropriately cranking the engine by the first rotating machine. In other words, since the value higher than the predetermined engine speed is set as the target engine speed when the request output is the output that needs the turbocharging pressure, even after the engine is brought into the operating state, it is possible to increase the engine speed after the autonomous operation more quickly by applying the torque for increasing the engine speed of the engine to the engine by the first rotating machine.

With the control device according to the aspect of the disclosure, when the engine is started, the output torque of the first rotating machine is controlled in the electric power generation state of the first rotating machine by controlling the output torque of the first rotating machine in a state where the first rotating machine is in a negative rotation. In this way, it is possible to increase the engine speed of the engine after the autonomous operation more quickly while suppressing the power consumption of the first rotating machine.

With the control device according to the aspect of the disclosure, when the engine is started, the target engine speed is set to a higher value as the vehicle speed increases when the request output for the engine is the output that needs turbocharging pressure. In this way, it is possible to set the target engine speed capable of further improving the rising response of turbocharging pressure while suppressing the deterioration of energy efficiency of the vehicle.

Further, with the control device according to the aspect of the disclosure, when the engine is started where the engine speed of is increased by the first rotating machine, the mechanical transmission mechanism is downshifted when the request output for the engine is the output that needs turbocharging pressure. In this way, the target engine speed is easily set to a high value while the first rotating machine can be maintained at the negative rotation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle to which the disclosure is applied, and illustrating a main part of a control function and a control system for various controls in the vehicle;

FIG. 2 is a diagram illustrating a schematic configuration of an engine;

FIG. 3 is an alignment chart relatively showing a rotation speed of each of rotating elements in a differential unit;

FIG. 4 is a diagram illustrating an example of an optimum engine operating point;

FIG. 5 is a diagram illustrating an example of a power source switching map used for switching control between motor traveling and hybrid traveling;

FIG. 6 is a table showing operating states of a clutch and a brake in each traveling mode;

FIG. 7 is a diagram illustrating an example of a cranking speed when turbocharging is needed, which is set based on a vehicle speed;

FIG. 8 is a diagram illustrating a setting example of a target cranking speed on an alignment chart;

FIG. 9 is a flowchart illustrating a main part of a control operation of an electronic control unit, that is, a control operation for improving rising response of turbocharging pressure while suppressing deterioration of energy efficiency in a vehicle at the time of starting an engine;

FIG. 10 is a diagram illustrating an example of a time chart when the control operation shown in the flowchart of FIG. 9 is executed;

FIG. 11 is a diagram illustrating a schematic configuration of a vehicle to which the disclosure is applied and which is different from the vehicle of FIG. 1;

FIG. 12 is an operation chart illustrating a relationship between a shift operation of a mechanical stepped transmission unit illustrated in FIG. 11 and an operation combination of engagement devices used therefor;

FIG. 13 is an alignment chart that relatively shows rotation speeds of respective rotating elements in an electric continuously variable transmission unit and a mechanical stepped transmission unit; and

FIG. 14 is a flowchart illustrating a main part of a control operation of an electronic control unit illustrated in FIG. 11, that is, a control operation for improving rising response of turbocharging pressure while suppressing deterioration of energy efficiency in a vehicle at the time of starting an engine.

### DETAILED DESCRIPTION OF EMBODIMENTS

Hereinafter, embodiments of the disclosure will be described in detail with reference to the drawings.

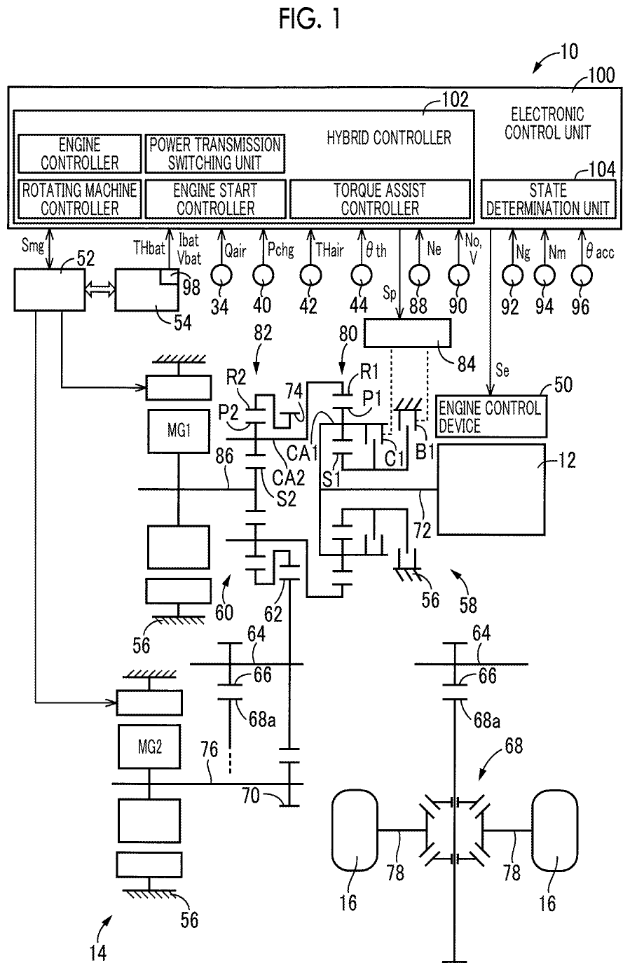

FIG. 1 is a diagram illustrating a schematic configuration of a vehicle 10 to which the disclosure is applied, and illustrating a main part of a control function and a control system for various controls in the vehicle 10. In FIG. 1, the vehicle 10 is a hybrid vehicle including an engine 12, a first rotating machine MG1, a second rotating machine MG2, a power transmission device 14, and drive wheels 16.

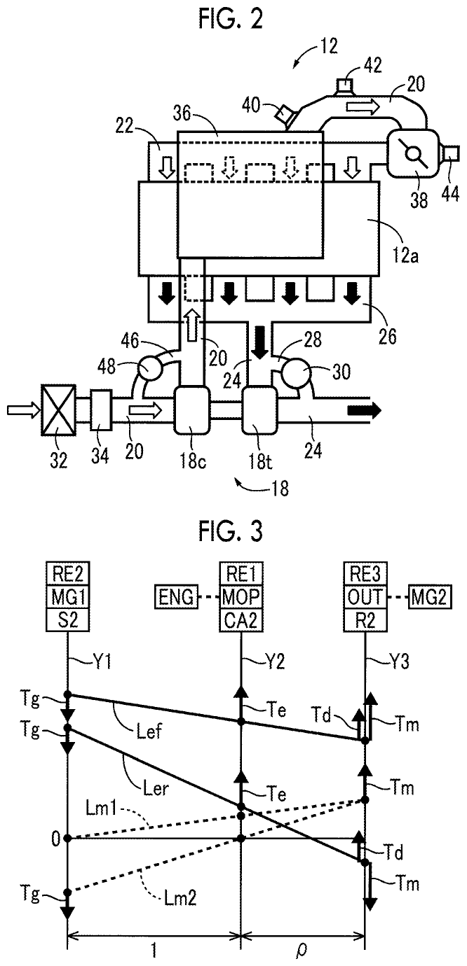

FIG. 2 is a diagram illustrating a schematic configuration of the engine 12. In FIG. 2, the engine 12 is a power source for causing the vehicle 10 to travel and is a known internal combustion engine such as a gasoline engine or a diesel engine having a turbocharger 18, that is, an engine with the turbocharger 18. An intake pipe 20 is provided in an intake system of the engine 12, and the intake pipe 20 is connected to an intake manifold 22 attached to an engine main body 12a. An exhaust pipe 24 is provided in an exhaust system of the engine 12, and the exhaust pipe 24 is connected to an exhaust manifold 26 attached to the engine main body 12a. The turbocharger 18 is a known exhaust turbine type turbocharger, that is, a turbocharger having a compressor 18c provided in the intake pipe 20 and a turbine 18t provided in the exhaust pipe 24. The turbine 18t is driven to rotate by the flow of discharging gas, that is, exhaust gas. The compressor 18c is connected to the turbine 18t, and compresses sucking air for the engine 12, that is, intake air, by being rotationally driven by the turbine 18t.

The exhaust pipe 24 is provided in parallel with an exhaust bypass 28 for bypassing the turbine 18t to flow exhaust gas from upstream to downstream of the turbine 18t. The exhaust bypass 28 is provided with a wastegate valve (WGV) 30 for continuously controlling the ratio between the exhaust gas passing through the turbine 18t and the exhaust gas passing through the exhaust bypass 28. The valve opening degree of the wastegate valve 30 is continuously adjusted by operating an actuator (not shown) by an electronic control unit 100 to be described later. The larger the valve opening degree of the wastegate valve 30 is, the more easily the exhaust gas of the engine 12 is discharged through the exhaust bypass 28. Therefore, in the turbocharging state of the engine 12 in which the turbocharging operation of the turbocharger 18 is effective, the turbocharging pressure Pchg by the turbocharger 18 decreases as the valve opening degree of the wastegate valve 30 increases. The turbocharging pressure Pchg by the turbocharger 18 is the pressure of the intake air, and is the air pressure downstream of the compressor 18c in the intake pipe 20. The low part of the turbocharging pressure Pchg is, for example, the part representing the intake pressure in the non-turbocharging state of the engine 12 in which the turbocharging operation of the turbocharger 18 is not effective at all, in other words, the part representing the pressure of intake air in the engine without the turbocharger 18.

An air cleaner 32 is provided at an inlet of the intake pipe 20, and an air flow meter 34 for measuring an intake air amount Qair of the engine 12 is provided in the intake pipe 20 downstream of the air cleaner 32 and upstream of the compressor 18c. An intercooler 36, which is a heat exchanger for cooling intake air compressed by the turbocharger 18 by performing heat exchange between the intake air and outside air or coolant, is provided in the intake pipe 20 downstream of the compressor 18c. An electronic throttle valve 38, which is controlled to be opened and closed by operating a throttle actuator (not shown) by an electronic control unit 100 to be described later, is provided in the intake pipe 20 downstream of the intercooler 36 and upstream of the intake manifold 22. In the intake pipe 20 between the intercooler 36 and the electronic throttle valve 38, a turbocharging pressure sensor 40 for detecting a turbocharging pressure Pchg by the turbocharger 18 and an intake air temperature sensor 42 for detecting an intake air temperature THair which is the temperature of the intake air are provided. In the vicinity of the electronic throttle valve 38, for example, in a throttle actuator, a throttle valve opening degree sensor 44 for detecting a throttle valve opening degree θth, which is an opening degree of the electronic throttle valve 38, is provided.

In the intake pipe 20, an air recirculation bypass 46 for bypassing the compressor 18c from downstream to upstream of the compressor 18c to recirculate air is provided in parallel. In the air recirculation bypass 46, for example, an air bypass valve (ABV) 48 is provided that is opened when the electronic throttle valve 38 is suddenly closed to suppress generation of surge and protect the compressor 18c.

In the engine 12, an engine control device 50 (refer to FIG. 1) including an electronic throttle valve 38, a fuel injection device, an ignition device, a wastegate valve 30, and the like, is controlled by the electronic control unit 100 to be described later, which, in turn, the engine torque Te, which is the output torque of the engine 12, is controlled.

Returning to FIG. 1, the first rotating machine MG1 and the second rotating machine MG2 are rotating electric machines having a function as an electric motor (motor) and a function as a generator, and are so-called motor generators. The first rotating machine MG1 and the second rotating machine MG2 can be power sources for the vehicle 10 to travel. Each of the first rotating machine MG1 and the second rotating machine MG2 is connected to a battery 54 provided in the vehicle 10 through an inverter 52 provided in the vehicle 10. In the first rotating machine MG1 and the second rotating machine MG2, an MG1 torque Tg, which is the output torque of the first rotating machine MG1, and an MG2 torque Tm, which is the output torque of the second rotating machine MG2 are controlled, respectively, by controlling the inverter 52 by the electronic control unit 100, which will be described later. For example, in the case of positive rotation, the output torque of the rotating machine is a powering torque at a positive torque during accelerating, and a regenerative torque at a negative torque during decelerating. The battery 54 is a power storage device that exchanges electric power with each of first rotating machine MG1 and second rotating machine MG2. The first rotating machine MG1 and the second rotating machine MG2 are provided in a case 56, which is a non-rotating member attached to the vehicle body.

The power transmission device 14 includes a transmission unit 58, a differential unit 60, a driven gear 62, a driven shaft 64, a final gear 66, a differential gear 68, a reduction gear 70, and the like, in the case 56. The transmission unit 58 and the differential unit 60 are arranged coaxially with an input shaft 72, which is an input rotating member of the transmission unit 58. The transmission unit 58 is connected to the engine 12 through the input shaft 72 or the like. The differential unit 60 is connected in series with the transmission unit 58. The driven gear 62 meshes with a drive gear 74, which is an output rotating member of the differential unit 60. The driven shaft 64 fixes the driven gear 62 and the final gear 66 such that the driven gear 62 and the final gear 66 cannot rotate relative to each other. The final gear 66 has a smaller diameter than the driven gear 62. The differential gear 68 meshes with the final gear 66 through a differential ring gear 68a. The reduction gear 70 has a smaller diameter than the driven gear 62 and meshes with the driven gear 62. The reduction gear 70 is connected to the rotor shaft 76 of the second rotating machine MG2, which is disposed in parallel with the input shaft 72 separately from the input shaft 72, and is connected to the second rotating machine MG2 to transmit power. In addition, the power transmission device 14 includes an axle 78 connected to the differential gear 68, and the like.

The power transmission device 14 configured as described above is suitably used for a front engine and front drive (FF) type and rear engine rear drive (RR) type vehicle. In the power transmission device 14, the power output from each of the engine 12, the first rotating machine MG1, and the second rotating machine MG2 is transmitted to the driven gear 62, and from the driven gear 62, the power is transmitted to the drive wheels 16 sequentially through the final gear 66, the differential gear 68, the axle 78 and the like. Thus, the second rotating machine MG2 is a rotating machine connected to the drive wheels 16 to transmit power. In the power transmission device 14, the engine 12, the transmission unit 58, the differential unit 60, and the first rotating machine MG1 are arranged on the different axis from the second rotating machine MG2, and thus the shaft length is reduced. Further, it is possible to increase the reduction ratio of the second rotating machine MG2. In addition, unless otherwise distinguished, power includes torque and force in terms of its meaning.

The transmission unit 58 includes a first planetary gear mechanism 80, a clutch C1, and a brake B1. The differential unit 60 includes a second planetary gear mechanism 82. The first planetary gear mechanism 80 is a known single pinion type planetary gear device including a first sun gear S1, a first pinion P1, a first carrier CA1 that rotatably and revolvably supports the first pinion P1, and a first ring gear R1 that meshes with the first sun gear S1 through the first pinion P1. The second planetary gear mechanism 82 is a known single pinion type planetary gear device including a second sun gear S2, a second pinion P2, a second carrier CA2 that rotatably and revolvably supports the second pinion P2, and a second ring gear R2 that meshes with the second sun gear S2 through the second pinion P2.

In the first planetary gear mechanism 80, the first carrier CA1 is a rotating element which is integrally connected to the input shaft 72, and to which the engine 12 is connected through the input shaft 72 to transmit power. The first sun gear S1 is a rotating element selectively connected to the case 56 through the brake B1. The first ring gear R1 is a rotating element connected to the second carrier CA2 of the second planetary gear mechanism 82, which is an input rotating member of the differential unit 60, and functions as an output rotating member of the transmission unit 58. Further, the first carrier CA1 and the first sun gear S1 are selectively connected through a clutch C1.

Each of the clutch C1 and the brake B1 is a wet friction engagement device, and is a multi-plate hydraulic friction engagement device where the engagement is controlled by a hydraulic actuator. With a hydraulic control circuit 84 provided in the vehicle 10 being controlled by an electronic control unit 100, which will be described later, operation states of the clutch C1 and the brake B1, such as engagement and release, are switched according to regulated hydraulic pressures Pc1 and Pb1 output from the hydraulic control circuit 84, respectively.

In a state where both the clutch C1 and the brake B1 are released, the differential of the first planetary gear mechanism 80 is allowed. Accordingly, in this state, since the reaction torque of the engine torque Te cannot be obtained in the first sun gear S1, the transmission unit 58 is in a neutral state in which mechanical power cannot be transmitted, that is, in a neutral state. In a state in which the clutch C1 is engaged and the brake B1 is released, the first planetary gear mechanism 80 has the rotating elements integrally rotated. Therefore, in this state, the rotation of the engine 12 is transmitted at a constant speed from the first ring gear R1 to the second carrier CA2. On the other hand, in a state where the clutch C1 is released and the brake B1 is engaged, in the first planetary gear mechanism 80, the rotation of the first sun gear S1 is stopped, and the rotation of the first ring gear R1 is faster than the rotation of the first carrier CA1. Therefore, in this state, the rotation of the engine 12 is accelerated and output from the first ring gear R1. As described above, the transmission unit 58 functions as a two-stage stepped transmission that allows the switching between a low gear with a gear ratio of “1.0”, meaning a direct coupled condition, and a high gear with a gear ratio of “0.7”, meaning an overdrive condition, for example. When the clutch C1 and the brake B1 are both engaged, the rotation of each rotating element of the first planetary gear mechanism 80 is stopped. Accordingly, in this state, the rotation of the first ring gear R1, which is the output rotating member of the transmission unit 58, is stopped, and thus the rotation of the second carrier CA2, which is the input rotating member of the differential unit 60, is stopped.

In the second planetary gear mechanism 82, the second carrier CA2 is a rotating element connected to the first ring gear R1, which is an output rotating member of the transmission unit 58, and functions as an input rotating member of the differential unit 60.

The second sun gear S2 is integrally connected to the rotor shaft 86 of the first rotating machine MG1, and is a rotating element to which the first rotating machine MG1 is connected to transmit power. The second ring gear R2 is integrally connected to the drive gear 74, is a rotating element connected to the drive wheels 16 to transmit power, and functions as an output rotating member of the differential unit 60. The second planetary gear mechanism 82 is a power split device mechanically splitting the power of the engine 12 to be input to the second carrier CA2 through the transmission unit 58 into the first rotating machine MG1 and the drive gear 74. That is, the second planetary gear mechanism 82 is a differential mechanism splitting the power of the engine 12 to transmit the split power to the drive wheels 16 and the first rotating machine MG1. In the second planetary gear mechanism 82, the second carrier CA2 functions as an input element, the second sun gear S2 functions as a reaction element, and the second ring gear R2 functions as an output element. The differential unit 60 forms, together with the first rotating machine MG1 which is connected to the second planetary gear mechanism 82 to transmit power, an electric transmission mechanism for controlling the differential state of the second planetary gear mechanism 82 by controlling the operation state of the first rotating machine MG1, for example, an electric continuously variable transmission. The first rotating machine MG1 is a rotating machine to which the power of the engine 12 is transmitted. Since the transmission unit 58 is overdriven, the increase in the torque of the first rotating machine MG1 is suppressed. It is to be noted that controlling the operation state of the first rotating machine MG1 means performing operation control of the first rotating machine MG1.

FIG. 3 is an alignment chart relatively showing a rotation speed of each of the rotating elements in the differential unit 60. In FIG. 3, three vertical lines Y1, Y2, and Y3 correspond to three rotating elements of the second planetary gear mechanism 82 constituting the differential unit 60. The vertical line Y1 represents the rotation speed of the second sun gear S2, which is the second rotating element RE2 to which the first rotating machine MG1 (see “MG1” in the figure) is connected to transmit power. The vertical line Y2 represents the rotation speed of the second carrier CA2, which is the first rotating element RE1 to which the engine 12 (see “ENG” in the figure) is connected through the transmission unit 58 to transmit power. The vertical line Y3 represents the rotation speed of the second ring gear R2, which is the third rotating element RE3, which is integrally connected to the drive gear 74 (see “OUT” in the figure), that is, which is connected to the drive wheels 16 to transmit power. As described above, the second planetary gear mechanism 82 is constituted by the second rotating element RE2, the first rotating element RE1, and the third rotating element RE3 in order from the first end to the second end on the alignment chart. The second rotating machine MG2 (see “MG2” in the figure) is connected to the driven gear 62 that meshes with the drive gear 74 through the reduction gear 70 and the like. A mechanical oil pump (see “MOP” in the figure) provided in the vehicle 10 is connected to the second carrier CA2. The mechanical oil-pump is used to supply oil for each engagement operation, lubrication of each part, and cooling of each part of the brake B1. When the rotation of the second carrier CA2 is stopped, oil is supplied by an electric oil pump (not shown) provided in the vehicle 10. The intervals between the vertical lines Y1, Y2, and Y3 are determined according to the gear ratio p of the second planetary gear mechanism 82 (the number of teeth of the sun gear/the number of teeth of the ring gear). When the space between the sun gear and the carrier is set to an interval corresponding to “1” in the relationship between the vertical axes of the alignment chart, the space between the carrier and the ring gear is set to an interval corresponding to the gear ratio ρ.

A solid line Lef in FIG. 3 indicates an example of relative speeds of respective rotating elements in forward traveling in an HV traveling mode, where the HV traveling mode is a traveling mode in which hybrid traveling (=HV traveling) is possible such that traveling is performed using at least the engine 12 as a power source. Further, a solid line Ler in FIG. 3 indicates an example of the relative speeds of respective rotating elements in backward traveling in the HV traveling mode. In the HV traveling mode, in the second planetary gear mechanism 82, for example, when the MG1 torque Tg generated by the first rotating machine MG1, which is a reaction torque of a negative torque with respect to the engine torque Te of the positive torque input to the second carrier CA2 through the transmission unit 58, is input to the second sun gear S2, a positive torque Td which is directly transmitted to the engine appears in the second ring gear R2. For example, in a case where the clutch Cl is engaged and the brake B1 is released and the transmission unit 58 is in the direct coupled condition of the gear ratio “1.0”, when the MG1 torque Tg (=−ρ/(1+ρ)×Te), which is the reaction torque with respect to the engine torque Te input to the second carrier CA2, is input to the second sun gear S2, the torque Td (=Te/(1+ρ)=−(1/ρ)×Tg) which is directly transmitted to the engine appears in the second ring gear R2. Then, according to the request driving force, the total torque of the torque Td directly transmitted to the engine and the MG2 torque Tm transmitted to the driven gear 62 can be transmitted to the drive wheels 16 as the drive torque of the vehicle 10. The first rotating machine MG1 functions as a generator when negative torque is generated by positive rotation. The battery 54 is charged with the generated electric power Wg of the first rotating machine MG1, and the second rotating machine MG2 consumes the generated electric power. The second rotating machine MG2 outputs the MG2 torque Tm by using all or some of the generated electric power Wg or by using the power from the battery 54 in addition to the generated electric power Wg. The MG2 torque Tm at the time of forward traveling is a powering torque that is a positive torque of positive rotation, and the MG2 torque Tm at the time of backward traveling is a powering torque that is a negative torque of negative rotation.

The differential unit 60 can be operated as an electric continuously variable transmission. For example, in the HV traveling mode, the operating state of the first rotating machine MG1 is controlled based on the output rotation speed No, which is the rotation speed of the drive gear 74 constrained by the rotation of the drive wheels 16, and thus the rotation speed of second carrier CA2 is increased or decreased when the rotation speed of the first rotating machine MG1, that is, the rotation speed of second sun gear S2 is increased or decreased. Since the second carrier CA2 is connected to the engine 12 through the transmission unit 58, the engine speed Ne, which is the engine speed of the engine 12, is increased or decreased by increasing or decreasing the rotation speed of the second carrier CA2. Therefore, in hybrid traveling, it is possible to perform control for setting the engine operating point OPeng to an efficient operating point. This type of hybrid is called a machine split type or a split type. The first rotating machine MG1 is a rotating machine capable of controlling the engine speed Ne, that is, a rotating machine capable of adjusting the engine speed Ne. The operating point is an operating point represented by the rotation speed and the torque, and the engine operating point OPeng is an operating point of the engine 12 represented by the engine speed Ne and the engine torque Te.

A dashed line Lm1 in FIG. 3 indicates an example of relative speeds of respective rotating elements in forward traveling, in a single drive EV mode in which motor traveling using just the second rotating machine MG2 as a power source can be performed, among motor traveling (=EV traveling) modes. A dashed line Lm2 in FIG. 3 indicates an example of relative speeds of respective rotating elements in forward traveling, in a dual drive EV mode in which motor traveling using both the first rotating machine MG1 and the second rotating machine MG2 as the power source can be performed, among the EV traveling modes.

The EV traveling mode is a traveling mode in which motor traveling can be performed by using at least one of the first rotating machine MG1 and the second rotating machine MG2 as a power source in a state where the operation of the engine 12 is stopped.

In the single drive EV mode, the clutch C1 and the brake B1 are both released, and the transmission unit 58 is in the neutral state, and thus the differential unit 60 is also in the neutral state. In this state, the MG2 torque Tm can be transmitted to the drive wheels 16 as drive torque of the vehicle 10. In the single drive EV mode, for example, in order to reduce drag loss or the like in the first rotating machine MG1, the first rotating machine MG1 is maintained at zero rotation. For example, even if control is performed to maintain the first rotating machine MG1 at zero rotation, since the differential unit 60 is in the neutral state, it does not affect the drive torque.

In the dual drive EV mode, the clutch C1 and the brake B1 are both engaged to stop the rotation of each of rotating elements of the first planetary gear mechanism 80, and thus the second carrier CA2 is stopped to zero rotation. In this state, the MG1 torque Tg and the MG2 torque Tm can be transmitted to the drive wheels 16 as drive torque of the vehicle 10.

Returning to FIG. 1, the vehicle 10 further includes the electronic control unit 100 as a controller including a control device of the vehicle 10 related to control of the engine 12, the first rotating machine MG1, the second rotating machine MG2, and the like. The electronic control unit 100 includes, for example, a so-called microcomputer having a CPU, a RAM, a ROM, an input/output interface, and the like. The CPU performs various controls of the vehicle 10 by using a temporary storage function of the RAM and performing signal processing according to a program stored in the ROM in advance. The electronic control unit 100 may include computers for engine control, rotating machine control, hydraulic control, and the like, as necessary.

The electronic control unit 100 receives various signals or the like (for example, the intake air amount Qair, the turbocharging pressure Pchg, the intake air temperature THair, the throttle valve opening degree θth, the engine speed Ne of the engine, the output rotation speed No corresponding to the vehicle speed V, the MG1 rotation speed Ng which is the rotation speed of the first rotating machine MG1, the MG2 rotation speed Nm which is the rotation speed of second rotating machine MG2, the accelerator operation amount θacc which is the accelerator operation amount of the driver indicating the magnitude of accelerator operation of the driver, the battery temperature THbat of battery 54, the battery charge/discharge current Ibat, the battery voltage Vbat, and the like) based on detection values by various sensors, or the like, provided in the vehicle 10 (for example, an air flow meter 34, a turbocharging pressure sensor 40, an intake air temperature sensor 42, a throttle valve opening degree sensor 44, an engine speed sensor 88, an output rotation speed sensor 90, an MG1 rotation speed sensor 92, an MG2 rotation speed sensor 94, an accelerator operation amount sensor 96, an battery sensor 98, and the like). From the electronic control unit 100, various command signals (for example, an engine control command signal Se for controlling the engine 12, a rotating machine control command signal Smg for controlling the first rotating machine MG1 and the second rotating machine MG2, a hydraulic control command signal Sp for controlling each operating state of clutch C1 and brake B1, and the like) are output to respective devices (for example, the engine control device 50, the inverter 52, the hydraulic control circuit 84, and the like) provided in the vehicle 10.

The electronic control unit 100 calculates a state of charge SOC [%] as a value indicating the state of charge of the battery 54 based on, for example, the battery charge/discharge current Ibat and the battery voltage Vbat. Further, the electronic control unit 100 calculates chargeable/dischargeable electric powers Win and Wout that define a usable range of the battery power Pbat, which is the power of the battery 54, based on, for example, the battery temperature THbat and the state of charge SOC of the battery 54. The chargeable/dischargeable electric powers Win and Wout are a chargeable power Win as an inputtable power that defines a limit on the input power of the battery 54 and a dischargeable power Wout as an outputable power that defines a limit on the output power of the battery 54, respectively. For example, the chargeable/dischargeable electric powers Win and Wout decreases as the battery temperature THbat decreases in a low temperature range where the battery temperature THbat is lower than the normal range, and decreases as the battery temperature THbat increases in a high temperature range where the battery temperature THbat is higher than the normal range. The chargeable electric power Win decreases as the state of charge SOC increases, for example, in a region where the state of charge SOC is high. The dischargeable electric power Wout decreases as the state of charge SOC decreases, for example, in a region where the state of charge SOC is low.

The electronic control unit 100 includes a hybrid control unit, that is, a hybrid controller 102 to implement various controls in the vehicle 10.

The hybrid controller 102 includes an engine control unit for controlling the operation of the engine 12, that is, functions as an engine control unit, a function as an engine controller, a rotating machine control unit for controlling the operations of the first rotating machine MG1 and the second rotating machine MG2 through the inverter 52, that is, a function as a rotating machine controller, and a power transmission switching unit for switching the power transmission state in the transmission unit 58, that is, a function as the power transmission switching unit, and with the above-mentioned control functions, performs hybrid drive control and the like by the engine 12, the first rotating machine MG1 and the second rotating machine MG2.

The hybrid controller 102 applies the accelerator operation amount θacc and the vehicle speed V to, for example, a driving force map, which is a relationship stored in advance experimentally or by design, that is, a predetermined relationship to calculate the request drive torque Twdem, which is the drive torque Tw requested for the vehicle 10. In other words, the request drive torque Twdem is the request drive power Pwdem at the vehicle speed V at that time. Here, an output rotation speed No or the like may be used instead of the vehicle speed V. As the driving force map, for example, different maps are set for forward traveling and backward traveling.

In order to implement the request drive power Pwdem by at least one power source of the engine 12, the first rotating machine MG1, and the second rotating machine MG2 in consideration of the request charge/discharge power, and the like, which is the charge/discharge power requested for the battery 54, the hybrid controller 102 outputs the engine control command signal Se, which is the command signal for controlling the engine 12 and the rotating machine control command signal Smg, which is the command signal for controlling the first rotating machine MG1 and the second rotating machine MG2.

For example, when the vehicle travels in the HV traveling mode, the engine control command signal Se is a command value of the engine power Pe that outputs the target engine torque Tetgt at the target engine speed Netgt in consideration of an optimum engine operating point OPengf, where the request engine power Pedem obtained by adding the request charge/discharge power, charge/discharge efficiency in the battery 54, or the like, to the request drive power Pwdem is implemented. Further, the rotating machine control command signal Smg is a command value of the generated electric power Wg of the first rotating machine MG1 that outputs the MG1 torque Tg at the rotation speed Ng of the MG1 at the time of command output as a reaction torque for setting the engine speed Ne to the target engine speed Netgt, and a command value of power consumption Wm of the second rotating machine MG2 that outputs the MG2 torque Tm at the rotation speed Nm of the MG2 at the time of command output. The MG1 torque Tg in the HV traveling mode is calculated, for example, in feedback control in which the first rotating machine MG1 is operated such that the engine speed Ne reaches the target engine speed Netgt. The MG2 torque Tm in the HV traveling mode is calculated to obtain the request drive torque Twdem, for example, in combination with the drive torque Tw based on the torque Td directly transmitted to the engine. The optimum engine operating point OPengf is predetermined, for example, as the engine operating point OPeng at which the total fuel efficiency of the vehicle 10 is in its best considering the charge/discharge efficiency of the battery 54 in addition to the fuel efficiency of the engine 12 alone, when the request engine power Pedem is achieved. The target engine speed Netgt is a target value of the engine speed Ne, that is, the target engine speed of the engine 12, and the target engine torque Tetgt is a target value of the engine torque Te. The engine power Pe is the output of the engine 12, that is, the power, and the request engine power Pedem is the output requested for the engine 12. As described above, the vehicle 10 is a vehicle that controls the MG1 torque Tg, which is the reaction torque of the first rotating machine MG1, such that the engine speed Ne is the target engine speed Netgt.

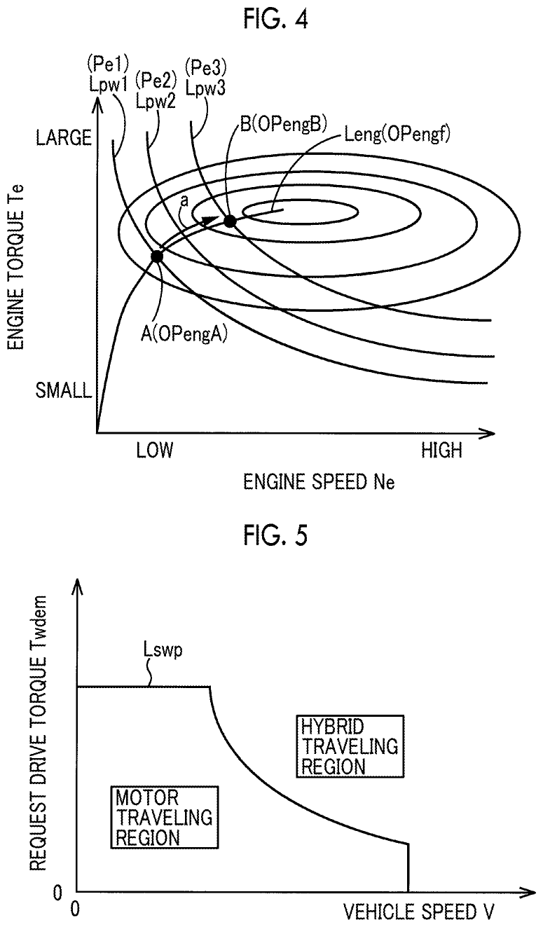

FIG. 4 is a diagram illustrating an example of optimum engine operating points OPengf on two-dimensional coordinates using the engine speed Ne and the engine torque Te as variables. In FIG. 4, a solid line Leng indicates a group of optimum engine operating points OPengf. The equal power lines Lpw1, Lpw2, and Lpw3 indicate an example when the request engine powers Pedem are the request engine power Pe1, Pe2, Pe3, respectively. Point A is an engine operating point OPengA when the request engine power Pe1 is achieved on the optimum engine operating point OPengf, and point B is an engine operating point OPengB when the request engine power Pe3 is achieved on the optimum engine operating point OPengf. The points A and B are also target values of the engine operating points OPeng represented by the target engine speed Netgt and the target engine torque Tetgt, that is, the target engine operating points OPengtgt. When the target engine operating point OPengtgt is changed from the point A to the point B due to an increase in the accelerator operation amount θacc, for example, control is performed such that the engine operating point OPeng is changed on the path a passing over the optimum engine operating point OPengf.

The hybrid controller 102 selectively establishes the EV traveling mode or the HV traveling mode as the traveling mode according to the traveling state, and causes the vehicle 10 to travel in each traveling mode. For example, when the request drive power Pwdem is in a motor traveling region smaller than the predetermined threshold, the hybrid controller 102 establishes the EV traveling mode, and when the request drive power Pwdem is in a hybrid traveling region equal to or greater than the predetermined threshold, the hybrid controller 102 establishes the HV traveling mode. Even when the request drive power Pwdem is in the motor traveling region, the hybrid controller 102 establishes the HV traveling mode when the state of charge SOC of the battery 54 is less than a predetermined engine start threshold or when the engine 12 needs to be warmed up. The engine start threshold is a predetermined threshold for determining whether or not the state of charge SOC is a value at which the battery 54 needs to be charged through forcible start of the engine 12.

FIG. 5 is a diagram illustrating an example of a power source switching map used for switching control between motor traveling and hybrid traveling. In FIG. 5, a solid line Lswp is a boundary line between the motor traveling region and the hybrid traveling region for switching between the motor traveling and the hybrid traveling. A region where the request drive power Pwdem is relatively small, in which the vehicle speed V is relatively low and the request drive torque Twdem is relatively small, is predetermined in the motor traveling region. A region where the request drive power Pwdem is relatively large, in which the vehicle speed V is relatively high or the request drive torque Twdem is relatively large, is predetermined in the hybrid traveling region. When the state of charge SOC of the battery 54 is less than the engine start threshold or when the engine 12 needs to be warmed up, the motor traveling region in FIG. 5 may be changed to the hybrid traveling region.

When the EV traveling mode is established, the hybrid controller 102 establishes the single drive EV mode when the request drive power Pwdem can be implemented just by the second rotating machine MG2. On the other hand, when the EV traveling mode is established, the hybrid controller 102 establishes the dual drive EV mode when the request drive power Pwdem cannot be implemented just by the second rotating machine MG2. Even when the request drive power Pwdem can be implemented just by the second rotating machine MG2, the hybrid controller 102 may establish the dual drive EV mode when it is more efficient to use the first rotating machine MG1 and the second rotating machine MG2 together than to use merely the second rotating machine MG2.

When the HV traveling mode is established when the operation of the engine 12 is stopped, the hybrid controller 102 functions as an engine start control unit for performing the engine start control for starting the engine 12, that is, functions as an engine start controller. When the engine 12 during rotation stop is to be started, the hybrid controller 102 controls the MG1 torque Tg to apply, to the engine 12, the torque for increasing the engine speed Ne, and starts the engine 12 by making ignition when the engine speed Ne is a predetermined engine speed Nest at which ignition is possible to bring the engine 12 into the operating state. When the engine 12 is started, the hybrid controller 102 applies, to the engine 12, a torque for rotating the engine 12 in a positive rotation direction, which is the rotation direction when the engine 12 is in the operating state, whereby the torque for increasing the engine speed Ne is applied to the engine 12. That is, the hybrid controller 102 starts the engine 12 by increasing the engine speed Ne by the first rotating machine MG1, that is, by cranking the engine 12 by the first rotating machine MG1. The predetermined rotation speed Nest is a predetermined engine speed Ne, for example, for starting fuel injection by a fuel injection device, that is, starting the fuel supply to the engine 12, and starting the application of voltage to the ignition device, that is, starting the operation of the engine 12 by igniting the engine 12, for example, a value of about 500 [rpm]. In the embodiment, the MG1 torque Tg controlled to apply the torque for increasing the engine speed Ne to the engine 12 is referred to as an MG1 cranking torque Tgcr.

The hybrid controller 102 controls each engagement operation of the clutch C1 and the brake B1 based on the established traveling mode. The hybrid controller 102 outputs, to the hydraulic control circuit 84, a hydraulic control command signal Sp for engaging and/or releasing each of the clutch C1 and the brake B1 such that power transmission for traveling in the established traveling mode is enabled.

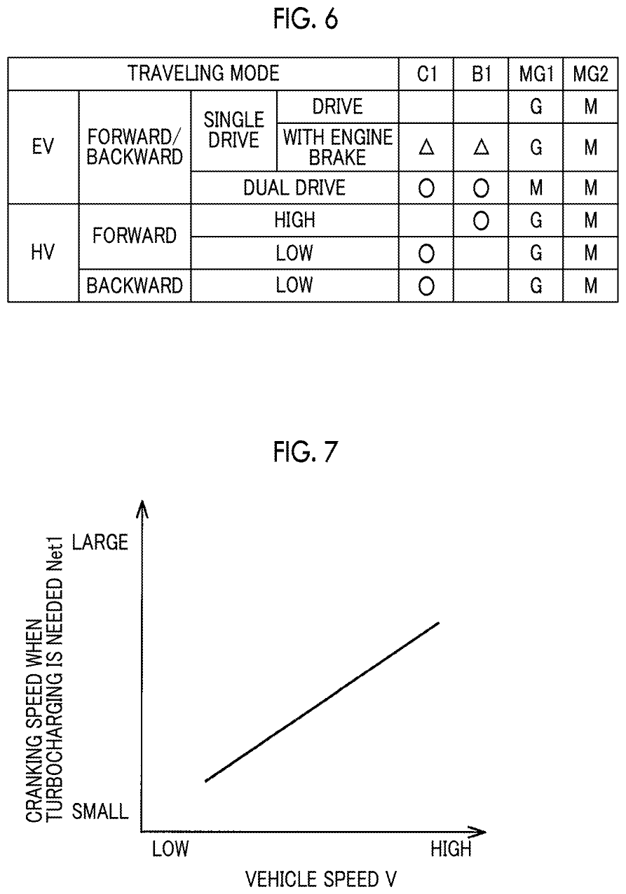

FIG. 6 is a table showing operation states of the clutch C1 and the brake B1 in each traveling mode. In FIG. 6, O mark indicates the engagement of each of the clutch C1 and the brake B1, blank indicates release, and A mark indicates that one of the two is engaged when the engine 12 in the rotation-stopped state is used together with the engine brake to bring the engine 12 into the rotation state. “G” mark indicates that the first rotating machine MG1 mainly functions as a generator, and “M” mark indicates that each of the first rotating machine MG1 and the second rotating machine MG2 mainly functions as a motor when it is driven, and mainly functions as a generator during regeneration. The vehicle 10 can selectively implement the EV traveling mode and the HV traveling mode as the traveling mode. The EV traveling mode has two modes: a single drive EV mode and a dual drive EV mode.

The single drive EV mode is implemented in a state where both the clutch C1 and the brake B1 are released. In the single drive EV mode, since the clutch C1 and the brake B1 are released, the transmission unit 58 is in the neutral state. When transmission unit 58 is set to the neutral state, the differential unit 60 is set to the neutral state in which the reaction torque of MG1 torque Tg is not taken in the second carrier CA2 connected to first ring gear R1.

In this state, the hybrid controller 102 causes the second rotating machine MG2 to output the MG2 torque Tm for traveling (see the dashed line Lm1 in FIG. 3). In the single drive EV mode, it is also possible to rotate the second rotating machine MG2 reversely with respect to forward traveling to travel backward.

In the single drive EV mode, the first ring gear R1 is rotated by the second carrier CA2, but since the transmission unit 58 is in the neutral state, the engine 12 is not rotated and is stopped at zero rotation. Therefore, when the regenerative control is performed by the second rotating machine MG2 during traveling in the single drive EV mode, a large regenerative amount can be obtained. When the battery 54 is fully charged and regenerative energy cannot be obtained during traveling in the single drive EV mode, it is conceivable to use an engine brake together. When the engine brake is used together, the brake B1 or the clutch C1 is engaged (see “WITH ENGINE BRAKE” in FIG. 6). When the brake B1 or the clutch C1 is engaged, the engine 12 is brought into the rotation state, and the engine brake is applied.

The dual drive EV mode is implemented in a state where the clutch C1 and the brake B1 are both engaged. In the dual drive EV mode, the rotation of each rotating element of the first planetary gear mechanism 80 is stopped by the engagement of the clutch C1 and the brake B1, the engine 12 is in a stopped state at zero rotation, and the rotation of the second carrier CA2 connected to the first ring gear R1 is also stopped. When the rotation of the second carrier CA2 is stopped, since the reaction torque of the MG1 torque Tg can be obtained in the second carrier CA2, the MG1 torque Tg can be mechanically output from the second ring gear R2 and transmitted to the drive wheels 16. In this state, the hybrid controller 102 causes the first rotating machine MG1 and the second rotating machine MG2 to output the MG1 torque Tg and the MG2 torque Tm for traveling (see the dashed line Lm2 in FIG. 3). In the dual drive EV mode, it is also possible to cause both the first rotating machine MG1 and the second rotating machine MG2 to rotate reversely with respect to forward traveling to travel backward.

The low state of the HV traveling mode is implemented in a state where the clutch C1 is engaged and a state where the brake B1 is released. In the low state of the HV traveling mode, since the clutch C1 is engaged, the rotating elements of the first planetary gear mechanism 80 are integrally rotated, and the transmission unit 58 is brought into a direct coupled condition. Therefore, the rotation of the engine 12 is transmitted at a constant speed from the first ring gear R1 to the second carrier CA2. The high state of the HV traveling mode is implemented when the brake B1 is engaged and the clutch C1 is released. In the high state of the HV traveling mode, the rotation of the first sun gear S1 is stopped by the engagement of the brake B 1, and the transmission unit 58 is brought into an overdrive condition. Therefore, the rotation of the engine 12 is accelerated and transmitted from the first ring gear R1 to the second carrier CA2. In the HV traveling mode, the hybrid controller 102 outputs the MG1 torque Tg, which is a reaction torque to the engine torque Te, by the electric power generation of the first rotating machine MG1, and outputs the MG2 torque Tm from the second rotating machine MG2 by the generated electric power Wg of the first rotating machine MG1 (see the solid line Lef in FIG. 3). In the HV traveling mode, for example, in the low state of the HV traveling mode, it is also possible to rotate the second rotating machine MG2 reversely with respect to the forward traveling to travel backward (see the solid line Ler in FIG. 3). In the HV traveling mode, it is possible to further add the MG2 torque Tm using the electric power from the battery 54 for traveling. In the HV traveling mode, for example, when the vehicle speed V is relatively high and the request drive torque Twdem is relatively small, the high state of the HV traveling mode is established.

When a request for starting the engine 12 is made, the delay in rising response of the turbocharging pressure Pchg may occur when the request engine power Pedem is a high output that needs the turbocharging pressure Pchg by the turbocharger 18. On the other hand, even after the engine 12 is cranked to the predetermined engine speed Nest by the first rotating machine MG1 to be in the operating state, it is conceivable that the rising response of the turbocharging pressure Pchg is improved by cranking the engine 12 by the first rotating machine MG1 to the engine speed Ne higher than the predetermined engine speed Nest. However, since a discharging state in which electric power is supplied from battery 54 occurs when MG1 cranking torque Tgcr is output in a state where first rotating machine MG1 is in the positive rotating state, the electric power consumption of the first rotating machine MG1 increases and thus it is likely that the energy efficiency in the vehicle 10 deteriorates.

Therefore, when the engine 12 is started, the hybrid controller 102 outputs the MG1 cranking torque Tgcr in a range of the engine speed Ne at which the first rotating machine MG1 can maintain an electric power generation state when the engine 12 is cranked by the first rotating machine MG1 up to the engine speed Ne higher than the predetermined engine speed

Nest. The first rotating machine MG1 can be maintained in the electric power generation state by outputting the MG1 cranking torque Tgcr in the state of the negative rotation. When the engine 12 is started, the hybrid controller 102 controls the MG1 torque Tg, that is, the MG1 cranking torque Tgcr in a state where the first rotating machine MG1 is in the state of the negative rotation. In this way, the MG1 cranking torque Tgcr is controlled in a state where the first rotating machine MG1 is generating electric power generation.

Specifically, the electronic control unit 100 further includes a state determination unit, that is, a state determination unit 104, in order to implement a control function for improving the rising response of the turbocharging pressure Pchg while suppressing deterioration of energy efficiency in the vehicle 10 when the engine 12 is started.

The state determination unit 104 determines whether or not the hybrid controller 102 has determined that the engine start control is to be performed. For example, when the request drive power Pwdem is set in the hybrid traveling region, when the state of charge SOC of the battery 54 is less than the engine start threshold, or when the engine 12 needs to be warmed up, the hybrid controller 102 determines that the engine start control is to be performed when the mode is shifted from the EV traveling mode to the HV traveling mode.

When determination is made that the hybrid controller 102 has determined that the engine start control is to be performed, the state determination unit 104 determines whether or not the request engine power Pedem after the engine is started is the output that needs the turbocharging pressure Pchg by the turbocharger 18. The state determination unit 104 determines whether or not the request engine power Pedem after the engine is started is an output that needs the turbocharging pressure Pchg based on, for example, whether or not the request engine power Pedem is equal to or greater than the predetermined request engine power Pedemf. The predetermined request engine power Pedemf is, for example, a predetermined lower limit of the engine power Pe by which determination can be made that the request engine power Pedem is the engine power Pe output in the turbocharging region where the turbocharging operation by the turbocharger 18 is effective.

The hybrid controller 102 sets a target cranking speed Necr which is a target engine speed of the engine 12 when the engine speed Ne is increased by the first rotating machine MG1. The hybrid controller 102 outputs the MG1 cranking torque Tgcr until the engine speed Ne is higher than the target cranking speed Necr, and continues the cranking of the engine 12 by the first rotating machine MG1. The hybrid controller 102 ends the cranking of the engine 12 by the first rotating machine MG1 when the engine speed Ne is higher than the target cranking speed Necr. The state determination unit 104 determines whether or not the engine speed Ne is higher than the target cranking speed Necr.

Specifically, the hybrid controller 102 sets the target cranking speed Necr to the predetermined engine speed Nest when the state determination unit 104 determines that the request engine power Pedem after the engine is started is not the output that needs the turbocharging pressure Pchg. Then, the hybrid controller 102 outputs the MG1 cranking torque Tgcr until the state determination unit 104 determines that the engine speed Ne is higher than the target cranking speed Necr, that is, the predetermined engine speed Nest, and brings the engine 12 into the operating state by igniting the engine 12 or the like when the engine speed Ne is higher than the predetermined engine speed Nest. Since the target cranking speed

Necr is the predetermined engine speed Nest, the hybrid controller 102 does not perform the cranking of the engine 12 by the first rotating machine MG1 after the engine 12 has been brought into the operating state.

On the other hand, the hybrid controller 102 sets the target cranking speed Necr to the cranking speed Net' when turbocharging is needed, when the state determination unit 104 determines that the request engine power Pedem after the engine is started is the output that needs the turbocharging pressure Pchg. The cranking speed Net1 when turbocharging is needed, is, for example, a predetermined target cranking speed Necr for improving the rising response of the turbocharging pressure Pchg after the engine 12 has been brought into the operating state, and is higher than the predetermined engine speed Nest. Then, the hybrid controller 102 outputs the MG1 cranking torque Tgcr and, brings the engine 12 into the operating state by igniting the engine 12 or the like, when the engine speed Ne is higher than the predetermined engine speed Nest. Then, the hybrid controller 102 outputs the MG1 cranking torque Tgcr until the state determination unit 104 determines that the engine speed Ne is higher than the target cranking speed Necr, that is, the cranking speed Net1 when turbocharging is needed.

For example, the cranking speed Net1 when turbocharging is needed may be set to a higher value as the request engine power Pedem after the engine is started is higher. In addition, as the vehicle speed V increases, that is, as the rotation speed of the second ring gear R2 (output rotation speed No) increases, the engine speed Ne that can be maintained in a region where the MG1 cranking torque Tgcr can be output in the state where the first rotating machine MG1 is in the negative rotation, that is, in an electric power generation region where the first rotating machine MG1 is in an electric power generation state, is increased. In order to make effective use of what is mentioned above, the cranking speed Net1 when turbocharging is needed may be set to a higher value as the vehicle speed V is higher, as shown in FIG. 7, for example. As described above, when the engine 12 is started, when the request engine power Pedem is the output that needs the turbocharging pressure Pchg, the hybrid controller 102 sets the target cranking speed Necr to be a higher value as the vehicle speed V increases.

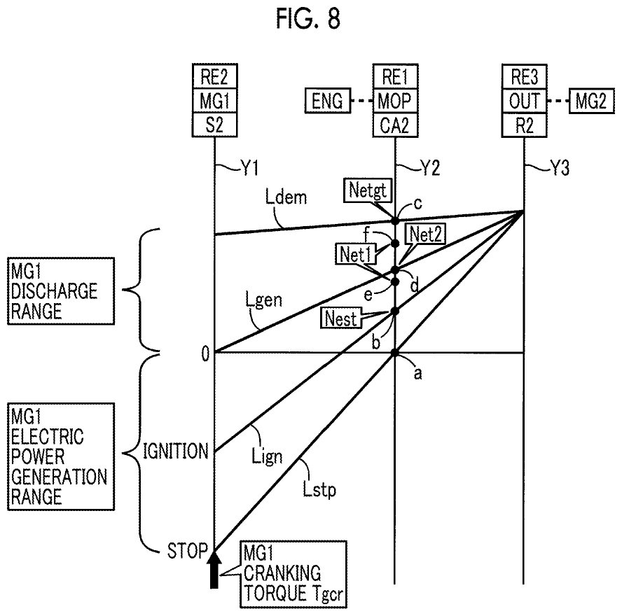

FIG. 8 is a diagram illustrating a setting example of the target cranking speed Necr on an alignment chart. The alignment chart shown in FIG. 8 is the same as the alignment chart shown in FIG. 3. In FIG. 8, a solid line Lstp indicates a state where the rotation of the engine 12 is stopped during traveling (see point a). When the MG1 cranking torque Tgcr is output in a state where the rotation of the engine 12 is stopped, the MG1 rotation speed Ng is increased and the engine speed Ne is also increased. When the engine speed Ne is increased to a predetermined engine speed Nest (see a point b) as shown by a solid line Lign, ignition, and the like for the engine 12 is performed and the engine 12 is brought into an operating state. When the request engine power Pedem is not the output that needs the turbocharging pressure Pchg, the predetermined engine speed Nest is set as the target cranking speed Necr. When the request engine power Pedem is the output that needs the turbocharging pressure Pchg, the cranking speed Net1 when turbocharging is needed, which is higher than the predetermined engine speed Nest, is set as the target cranking speed Necr. As a result, even after the engine 12 has been brought into the operating state, the MG1 cranking torque Tgcr is output and the engine 12 is cranked until the engine speed Ne reaches the cranking speed Net1 when the turbocharging is needed. When the engine speed Ne reaches the cranking speed Net1 when turbocharging is needed, the cranking by the first rotating machine MG1 is ended, and as shown by the solid line Ldem, the engine 12 increases the engine speed Ne to the target engine speed Netgt (see point c) that implements the request engine power Pedem by its own power. In this case, the MG1 torque Tg, which is a reaction torque of negative torque by first rotating machine MG1, is input to the second sun gear S2.

When the engine speed Ne is increased by the cranking of the first rotating machine MG1 to the set cranking speed Net1 when turbocharging is needed, the first rotating machine MG1 may not be able to be maintained in the electric power generation state. In the state where the first rotating machine MG1 is in the negative rotation, the first rotating machine MG1 is brought into the electric power generation state when the MG1 cranking torque Tgcr is output. In contrast, in the state where the first rotating machine MG1 is in the positive rotation, the first rotating machine MG1 is brought into the discharging state when the MG1 cranking torque Tgcr is output. As shown by the solid line Lgen, when the cranking speed Net1 (see point e) when turbocharging is needed is set to be lower than the electric power generation possible cranking speed Net2 (see point d) which is the engine speed Ne when the MG1 rotation speed Ng is zero, the first rotating machine MG1 can be maintained in the electric power generation state when the MG1 cranking torque Tgcr is output. However, when the cranking speed Net1 (see point f) when turbocharging is needed is set to be higher than the electric power generation possible cranking speed Net2, the first rotating machine MG1 cannot be maintained in the electric power generation state when the MG1 cranking torque Tgcr is output. Therefore, when the cranking speed Net1 when turbocharging is needed is higher than the electric power generation possible cranking speed Net2, the hybrid controller 102 sets the electric power generation possible cranking speed Net2 as the target cranking speed Necr instead of the cranking speed Net1 when turbocharging is needed. Accordingly, in the region where the first rotating machine MG1 is in the discharging state, the cranking by the first rotating machine MG1 is not performed. The hybrid controller 102 uses, for example, a relative relational expression at each of the rotation speeds of the three rotating elements RE1, RE2, RE3 of the second planetary gear mechanism 82 to calculate the engine speed Ne corresponding to the rotation speed of the second carrier CA2 at the rotation speed of the second ring gear R2 (=output rotation speed No) when the rotation speed of the second sun gear S2 (=MG1 rotation speed Ng) is zero, as the electric power generation possible cranking speed Net2.

When determination is made that the request engine power Pedem after the engine is started is the output that needs the turbocharging pressure Pchg, the state determination unit 104 determines whether or not the cranking by the first rotating machine MG1 can be performed in the electric generation region in which the first rotating machine MG1 is in the electric power generation state when the engine speed Ne is increased to the cranking speed Net1 when turbocharging is needed which is set as the target cranking speed Necr by the hybrid controller 102, for example, based on whether or not the cranking speed Net1 when turbocharging is needed is equal to or less than the electric power generation possible cranking speed Net2.

When the state determination unit 104 determines that the cranking by the first rotating machine MG1 can be performed in the electric power generation region of the first rotating machine MG1, the hybrid controller 102 directly sets the cranking speed Net1 when turbocharging is needed as the target cranking speed Necr. On the other hand, when the state determination unit 104 determines that cranking by the first rotation machine MG1 cannot be performed in the electric power generation region of the first rotating machine MG1, the hybrid controller 102 sets the electric power generation possible cranking speed Net2 as the target cranking speed Necr, in place of the cranking speed Net1 when turbocharging is needed.

As described above, when the engine 12 is started, the hybrid controller 102 sets the target cranking speed Necr to a value at which the first rotating machine MG1 is maintained in the electric power generation state when the request engine power Pedem is the output that needs the turbocharging pressure Pchg and which is higher than when the request engine power Pedem is not the output that needs the turbocharging pressure Pchg, and even after the engine 12 is brought into the operating state, controls the MG1 cranking torque Tgcr to apply, to the engine 12, the torque for increasing an engine speed Ne to the target cranking speed Necr.

Since the cranking by the first rotating machine MG1 is performed in the electric power generation region of the first rotating machine MG1, the MG2 torque Tm is output from the second rotating machine MG2 by using the generated electric power Wg of the first rotating machine MG1 at this time. Thus, the request drive torque Twdem may be compensated. When the engine 12 is started where the engine speed Ne is increased by the first rotation machine MG1, the hybrid controller 102 functions as a torque assist control unit, that is, a torque assist controller that outputs some of the drive torque Tw from the second rotating machine MG2 by using the electric power Wg generated by the first rotating machine MG1 in the electric power generation state. In particular, the torque assist by the second rotating machine MG2 is useful when the request engine power Pedem is the output that needs the turbocharging pressure Pchg.

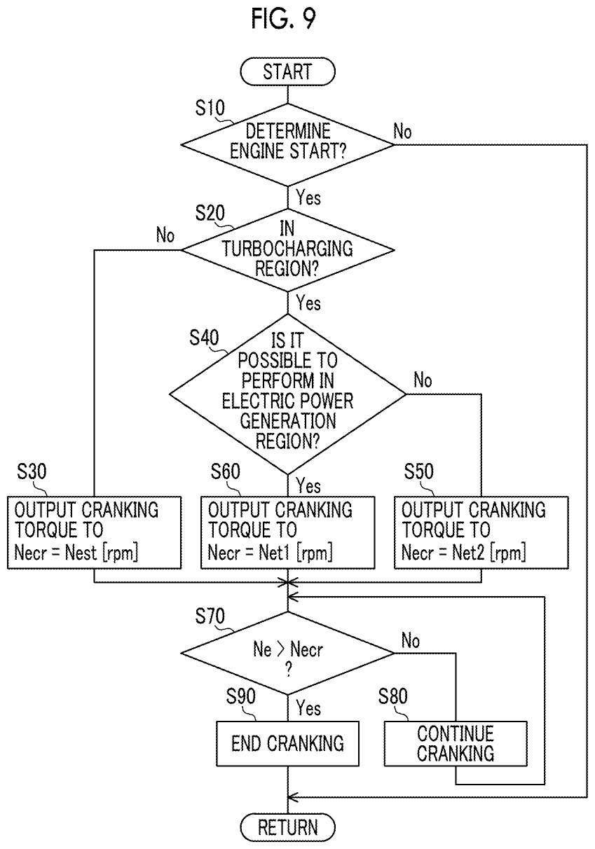

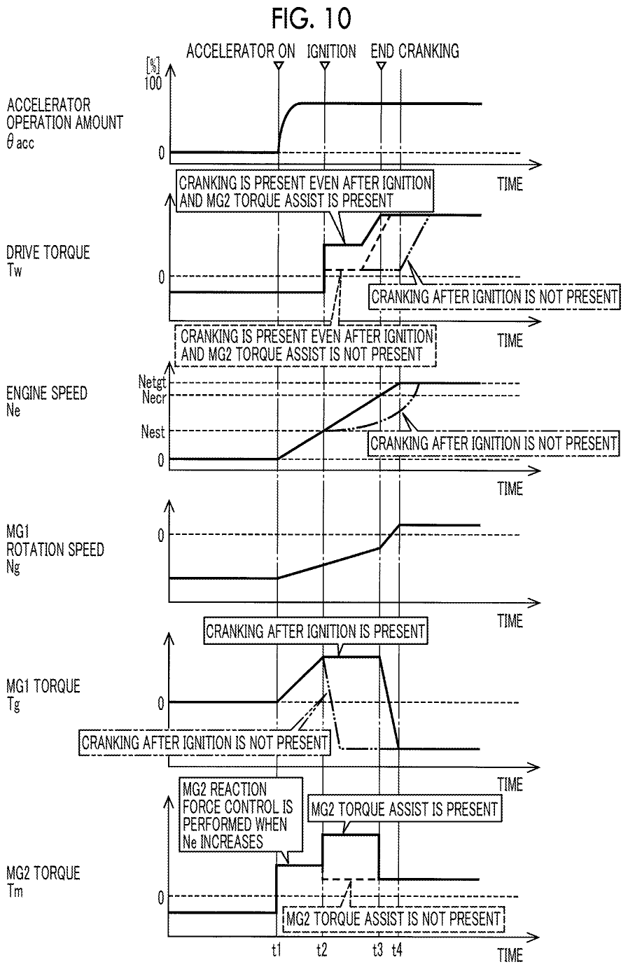

FIG. 9 is a flowchart illustrating a main part of a control operation of the electronic control unit 100, that is, a control operation for improving rising response of the turbocharging pressure Pchg while suppressing deterioration of energy efficiency in the vehicle 10 at the time of starting the engine 12, which is repeatedly executed. FIG. 10 is a diagram illustrating an example of a time chart when the control operation shown in the flowchart of FIG. 9 is executed.

In FIG. 9, first, in step (hereinafter, step is omitted) S10 corresponding to the function of the state determination unit 104, determination is made whether or not a determination to perform the engine start control has been made. When the determination in

S10 is negative, this routine ends. When the determination in S10 is affirmative, in S20 corresponding to the function of the state determination unit 104, determination is made whether or not the request engine power Pedem after the engine is started is an output that needs the turbocharging pressure Pchg, that is, the request engine power Pedem is in the turbocharging region. When the determination in S20 is negative, in S30 corresponding to the function of the hybrid controller 102, a predetermined engine speed Nest is set as the target cranking speed Necr, the MG1 cranking torque Tgcr is output until the engine speed Ne reaches the predetermined engine speed Nest, and the engine 12 is brought into the operating state by ignition or the like when the engine speed Ne reaches the predetermined engine speed Nest. When the determination in S20 is affirmative, in S40 corresponding to the function of the state determination unit 104, when the engine speed Ne is increased to the cranking speed Net1 when turbocharging is needed, determination is made whether or not cranking by first rotating machine MG1 can be performed in the electric power generation region of the first rotating machine MG1. When the determination in S40 is negative, in S50 corresponding to the function of the hybrid controller 102, the electric power generation possible cranking speed Net2 is set as the target cranking speed Necr, and the engine 12 is brought into the operating state by ignition or the like when the engine speed Ne reaches the predetermined engine speed Nest by the cranking by the first rotating machine MG1. Then, the MG1 cranking torque Tgcr is output until the engine speed Ne reaches the electric power generation possible cranking speed Net2. When the determination in S40 is affirmative, in S60 corresponding to the function of the hybrid controller 102, the cranking speed Net1 when turbocharging is needed is set as the target cranking speed Necr, and the engine 12 is brought into the operating state by ignition or the like when the engine speed Ne reaches the predetermined engine speed Nest by the cranking by the first rotating machine MG1. Then, the MG1 cranking torque Tgcr is output until the engine speed Ne reaches the cranking speed Net1 when turbocharging is needed. Subsequent to S30, or subsequent to S50, or subsequent to S60, in S70 corresponding to the function of the state determination unit 104, determination is made whether or not the engine speed Ne is higher than the target cranking speed Necr. When the determination in S70 is negative, in S80 corresponding to the function of the hybrid controller 102, the cranking of the engine 12 by the first rotating machine MG1 is continued. When the cranking of the engine 12 is continued even after the engine 12 has been brought into the operating state, the engine speed Ne is increased faster than the engine 12 increases the engine speed Ne by its own power, and the rising of the turbocharging pressure Pchg is accelerated. In this way, the response of the engine torque Te is improved. In this case, an increase in the generated electric power Wg of first rotating machine MG1 is expected. Subsequent to S80, S70 is repeatedly executed. When the determination in S70 is affirmative, in S90 corresponding to the function of the hybrid controller 102, the cranking of the engine 12 by the first rotating machine MG1 is ended. In the electric power generation region of the first rotating machine MG1, that is, during performing cranking by the first rotating machine MG1, torque assist by the second rotating machine MG2 is performed by using the generated electric power Wg of the first rotating machine MG1.

FIG. 10 is a diagram illustrating an example in which the request engine power Pedem after the engine is started is an output that needs the turbocharging pressure Pchg. In FIG. 10, a time t1 indicates a time at which the operation of the driver stepping on the accelerator is performed (accelerator-on operation). Determination is made that the engine start control is to be performed by the accelerator-on operation, and the cranking of the engine 12 by the first rotating machine MG1 is performed (see time t1 and thereafter). When the engine speed Ne is increased to the predetermined engine speed Nest, the engine 12 is brought into an operating state by ignition or the like (see time t2). In the embodiment shown by solid lines, the target cranking speed Necr higher than the predetermined engine speed Nest is set, and even after the engine 12 is started, the engine speed Ne is increased to the target cranking speed Necr by the cranking by the first rotating machine MG1 (see time t2 to the time t3). As a result, in the embodiment, the increase in the engine speed Ne is accelerated, and the rising response of the turbocharging pressure Pchg is improved, as compared to a comparative example indicated by a two-dot chain line in which the cranking is not performed after ignition. Further, in the embodiment, the torque assist by the second rotating machine MG2 is performed using the generated electric power Wg of the first rotating machine MG1 during performing cranking after ignition (see time t2 to time t3). As a result, in the embodiment, deterioration of the acceleration response due to the delay in the rising response of the turbocharging pressure Pchg is suppressed, as compared to a comparative example indicated by a dashed line in which the torque assist by the second rotating machine MG2 is not performed. Further, in the embodiment, after the engine speed Ne is the target cranking speed Necr and the cranking by the first rotating machine MG1 is ended, the engine speed Ne is increased to the target engine speed Netgt that achieves the request engine power Pedem by the power of the engine 12 itself (see time t3 to time t4). During performing cranking by the first rotating machine MG1, MG2 reaction force control is performed to output a reaction torque corresponding to the MG1 cranking torque Tgcr to the second rotating machine MG2.

As described above, according to the embodiment, when the engine 12 during rotation stop is started, the target cranking speed Necr is set to a value at which the first rotating machine MG1 is maintained in an electric power generation state when the request engine power Pedem is the output that needs the turbocharging pressure Pchg and which is higher than when the request engine power Pedem is not the output that needs the turbocharging pressure Pchg. Also, even after the engine 12 is brought into the operating state, the MG1 cranking torque Tgcr is controlled to apply, to the engine 12, the torque for increasing the engine speed Ne to the target cranking speed Necr. In this way, it is possible to increase the engine speed Ne after an autonomous operation more quickly while suppressing power consumption of the first rotating machine MG1. Therefore, when the engine 12 is started, it is possible to improve the rising response of the turbocharging pressure Pchg while suppressing the deterioration of energy efficiency in the vehicle 10.

According to the embodiment, some of a drive torque Tw from the second rotating machine MG2 is output by using electric power Wg generated by the first rotating machine MG1 in the electric power generation state, when the engine 12 is started where the engine speed Ne is increased by the first rotating machine MG1. In this way, it is possible to suppress the deterioration of acceleration response due to the delay in the rising response of the turbocharging pressure Pchg.

Further, according to the embodiment, when the request engine power Pedem is not the output that needs the turbocharging pressure Pchg, the target cranking speed Necr is set to the predetermined engine speed Nest. Thus, the engine 12 can be brought into an operating state by appropriately cranking the engine 12 by the first rotating machine MG1. In other words, since the value higher than the predetermined engine speed Nest is set as the target cranking speed Necr when the request engine power Pedem is the output that needs the turbocharging pressure Pchg, even after the engine 12 has been brought into the operating state, it is possible to increase the engine speed Ne after the autonomous operation more quickly by applying the torque for increasing the engine speed Ne to the engine 12 by the first rotating machine MG1.

According to the embodiment, when the engine 12 is started, the MG1 cranking torque Tgcr is controlled in the electric power generation state of the first rotating machine MG1 by controlling the MG1 cranking torque Tgcr in a state where the first rotating machine MG1 is in the negative rotation. In this way, it is possible to increase the engine speed Ne after the autonomous operation more quickly while suppressing the power consumption of the first rotating machine MG1.

According to the embodiment, when the engine 12 is started, the target cranking speed Necr is set to a higher value as the vehicle speed V increases when the request engine power Pedem is the output that needs the turbocharging pressure Pchg. In this way, it is possible to set the target cranking speed Necr capable of further improving the rising response of the turbocharging pressure Pchg while suppressing the deterioration of energy efficiency in the vehicle 10.

Next, other embodiments of the disclosure will be described. In the following description, portions common to the embodiments are denoted by the same reference signs, and description thereof is omitted.

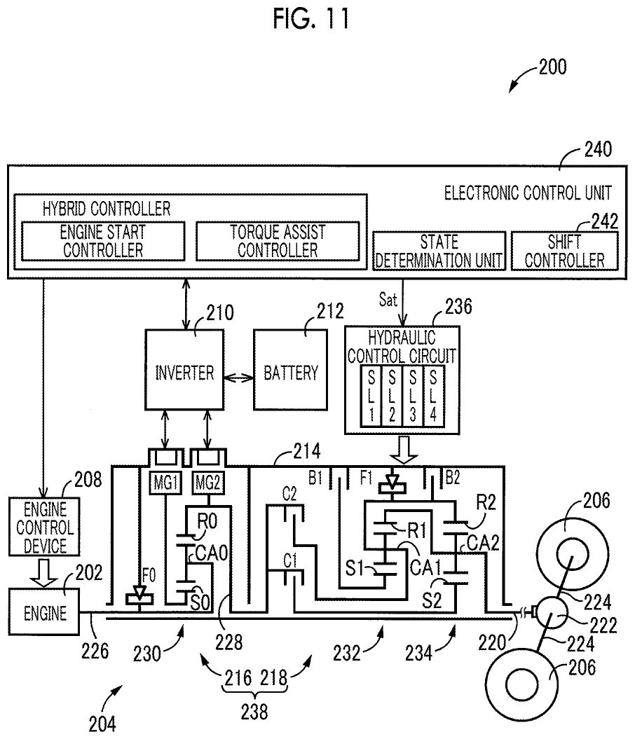

The embodiment exemplifies a vehicle 200 as shown in FIG. 11, which is different from the vehicle 10 shown in the above first embodiment. FIG. 11 is a diagram illustrating a schematic configuration of a vehicle 200 to which the disclosure is applied. In FIG. 11, the vehicle 200 is a hybrid vehicle including an engine 202, a first rotating machine MG1, a second rotating machine MG2, a power transmission device 204, and drive wheels 206.

The engine 202, the first rotating machine MG1, and the second rotating machine MG2 have the same configuration as the engine 12, the first rotating machine MG1, and the second rotating machine MG2 described in the first embodiment. In the engine 202, the engine torque Te is controlled by controlling an engine control device 208, such as an electronic throttle valve, a fuel injection device, an ignition device, and a wastegate valve provided in the vehicle 200, by an electronic control unit 240 to be described later. Each of the first rotating machine MG1 and the second rotating machine MG2 is connected to a battery 212 provided in the vehicle 200 through an inverter 210 provided in the vehicle 200. In the first rotating machine MG1 and the second rotating machine MG2, the MG1 torque Tg and the MG2 torque Tm are controlled by controlling the inverter 210 by the electronic control unit 240, respectively.

The power transmission device 204 includes an electric continuously variable transmission unit 216, a mechanical stepped transmission unit 218, and the like, which are arranged in series on a common axis in a case 214 as a non-rotating member mounted to the vehicle body. The electric continuously variable transmission unit 216 is directly or indirectly connected to the engine 202 through a damper (not shown) or the like. The mechanical stepped transmission unit 218 is connected to the output side of the electric continuously variable transmission unit 216. The power transmission device 204 includes a differential gear device 222 connected to an output shaft 220 which is an output rotating member of the mechanical stepped transmission unit 218, a pair of axles 224 connected to the differential gear device 222, and the like. In the power transmission device 204, power output from the engine 202 and the second rotating machine MG2 is transmitted to the mechanical stepped transmission unit 218, and is transmitted from the mechanical stepped transmission unit 218 to the drive wheels 206 through the differential gear device 222 and the like. The power transmission device 204 configured as described above is suitably used for a vehicle of a front engine and rear drive (FR) system. Hereinafter, the electric continuously variable transmission unit 216 is referred to as a continuously variable transmission unit 216, and the mechanical stepped transmission unit 218 is referred to as a stepped transmission unit 218. Further, the continuously variable transmission unit 216, the stepped transmission unit 218, and the like are configured substantially symmetrically with respect to the common axis, and the lower half of the axis is omitted in FIG. 11. The common axis is the axis of a crankshaft of the engine 202, a connection shaft 226 connected to the crankshaft, and the like.

The continuously variable transmission unit 216 includes a differential mechanism 230 as a power split device mechanically splitting the power of the engine 202 into the first rotating machine MG1 and the intermediate transmission member 228 that is the output rotating member of the continuously variable transmission unit 216. The first rotating machine MG1 is a rotating machine to which the power of the engine 202 is transmitted. The second rotating machine MG2 is connected to the intermediate transmission member 228 to transmit power. Since the intermediate transmission member 228 is connected to the drive wheels 206 through the stepped transmission unit 218, the second rotating machine MG2 is a rotating machine connected to the drive wheels 206 to transmit power. The differential mechanism 230 is a differential mechanism that splits the power of the engine 202 to transmit the split power to the drive wheels 206 and the first rotating machine MG1. The continuously variable transmission unit 216 is an electric transmission mechanism, for example, an electric continuously variable transmission, in which the differential state of the differential mechanism 230 is controlled by controlling the operation state of the first rotating machine MG1. The first rotating machine MG1 is a rotating machine capable of controlling the engine speed Ne, that is, a rotating machine capable of adjusting the engine speed Ne.

The differential mechanism 230 may be a single pinion type planetary gear device, and includes a sun gear S0, a carrier CA0, and a ring gear R0. The engine 202 is connected to the carrier CA0 through the connection shaft 226 to transmit power, the sun gear S0 is connected to the first rotating machine MG1 to transmit power, and the ring gear R0 is connected to the second rotating machine MG2 to transmit power. In the differential mechanism 230, the carrier CA0 functions as an input element, the sun gear S0 functions as a reaction element, and the ring gear R0 functions as an output element.

The stepped transmission unit 218 is a stepped transmission that forms a part of a power transmission path between the intermediate transmission member 228 and the drive wheels 206, that is, a mechanical transmission mechanism that forms a part of a power transmission path between the continuously variable transmission unit 216 (meaning the same for the differential mechanism 230) and the drive wheels 206. The intermediate transmission member 228 also functions as an input rotating member of the stepped transmission unit 218. The stepped transmission unit 218 is a known planetary gear type automatic transmission including, for example, a plurality of sets of planetary gear devices of a first planetary gear device 232 and a second planetary gear device 234, and a plurality of engagement devices of the clutch C1, the clutch C2, the brake B1, and the brake B2, together with the one-way clutch F1. Hereinafter, the clutch C1, the clutch C2, the brake B1, and the brake B2 are simply referred to as an engagement device CB unless otherwise specified.

The engagement device CB is a hydraulic friction engagement device including a multi-plate or single-plate clutch or brake pressed by a hydraulic actuator, a band brake tightened by a hydraulic actuator, and the like. The engagement device CB switches the operating state, such as engagement or release, by changing the engagement torque Tcb, which is torque capacity, with the regulated engagement hydraulic pressure PRcb of the engagement device CB output from each of solenoid valves SL1 to SL4 and the like in a hydraulic control circuit 236 provided in the vehicle 200.

The stepped transmission unit 218 is configured such that the rotating elements of the first planetary gear device 232 and the second planetary gear device 234 are partially connected to each other directly or indirectly through the engagement device CB or the one-way clutch F1, or connected to the intermediate transmission member 228, the case 214, or the output shaft 220. The rotating elements of the first planetary gear device 232 is a sun gear S1, a carrier CA1, and a ring gear R1, and rotating elements of the second planetary gear device 234 is a sun gear S2, a carrier CA2, and a ring gear R2.

When any one of the engagement devices is engaged, in the stepped transmission unit 218, any one is formed among plurality of gear stages having different gear ratios γat (=AT input rotation speed Ni/AT output rotation speed No). In the embodiment, the gear stage formed by a stepped transmission unit 218 is referred to as an AT gear stage. The AT input rotation speed Ni is the input rotation speed of the stepped transmission unit 218, has the same value as the rotation speed of the intermediate transmission member 228, and has the same value as the MG2 rotation speed Nm. The AT output rotation speed No is the rotation speed of the output shaft 220 that is the output rotation speed of the stepped transmission unit 218, and is also the output rotation speed of the composite transmission 238, which is the entire transmission including the continuously variable transmission unit 216 and the stepped transmission unit 218.

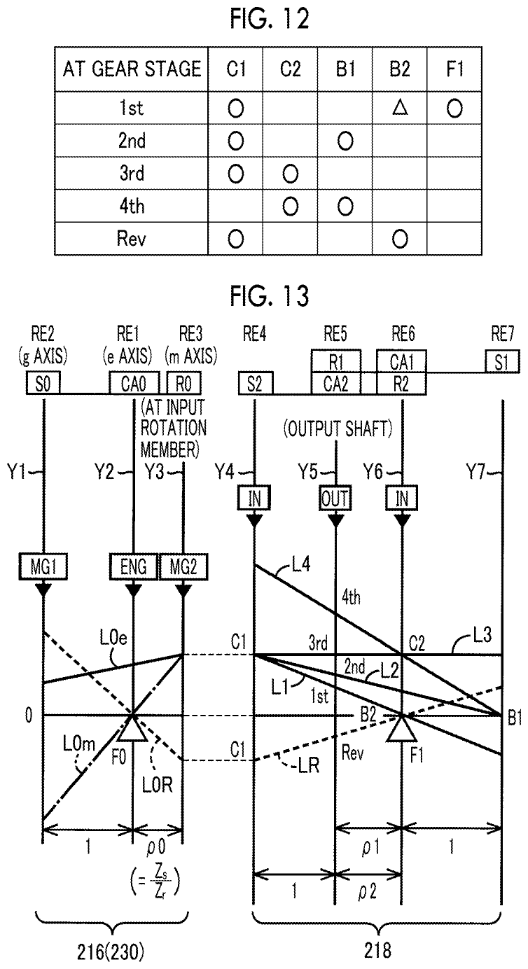

As shown in the engagement operation table of FIG. 12, for example, the stepped transmission unit 218 includes, as a plurality of AT gear stages, an AT first gear stage (“1st” in the figure) to an AT fourth gear stage (“4th” in the figure), that is, four forward AT gear stages. The gear ratio γat of the AT first gear stage is the largest, and the gear ratio yat is smaller as the AT gear stage is higher. The reverse AT gear stage (“Rev” in the figure) is formed, for example, by engagement of the clutch C1 and engagement of the brake B2. That is, as will be described later, when the vehicle travels in the reverse direction, for example, the AT first gear stage is formed. The engagement operation table in FIG. 12 summarizes the relationship between AT gear stages and operating states of the engagement devices. In FIG. 12, “0” mark indicates engagement, “A” mark indicates engagement during engine braking or coast-down shift of the stepped transmission unit 218, and blank indicates release.

In the stepped transmission unit 218, an AT gear stage formed according to an accelerator operation by a driver (a person who drives a vehicle), a vehicle speed V, and the like is switched by an electronic control unit 240 to be described later, that is, the AT gear stages is selectively provided. For example, in the shift control of the stepped transmission unit 218, shift is performed by any switch-over of the engagement device CB, that is, a so-called clutch-to-clutch shift is performed where shift is performed by switching between engagement and release of the engagement device CB.

The vehicle 200 further includes a one-way clutch F0. The one-way clutch F0 is a lock mechanism that can fix the carrier CA0 such that the carrier CA0 cannot rotate.

That is, the one-way clutch F0 is a lock mechanism that can fix, to the case 214, the connection shaft 226 connected to the crankshaft of the engine 202 and rotating integrally with the carrier CA0. In the one-way clutch F0, first member of two relatively rotatable members is integrally connected to the connection shaft 226, and second member is integrally connected to the case 214. The one-way clutch F0 runs idle in a positive rotation direction, which is a rotation direction during operation of the engine 202, and automatically engages in a rotation direction opposite to the rotation direction during operation of the engine 202. Accordingly, when the one-way clutch F0 runs idle, the engine 202 is in a state capable of rotating relative to the case 214. On the other hand, when the one-way clutch F0 is engaged, the engine 202 is not in the state capable of rotating relative to the case 214. That is, the engine 202 is fixed to the case 214 by the engagement of the one-way clutch F0. Thus, one-way clutch F0 allows rotation of carrier CA0 in the positive rotation direction, which is the rotation direction during operation of the engine 202, and suppresses rotation of carrier CA0 in the negative rotation direction. That is, the one-way clutch F0 is a lock mechanism that allows rotation of the engine 202 in the positive rotation direction and suppresses rotation of the engine 202 in the negative rotation direction.

FIG. 13 is an alignment chart that relatively shows rotation speeds of respective rotating elements in a continuously variable transmission unit 216 and the stepped transmission unit 218. In FIG. 13, three vertical lines Y1, Y2, and Y3 corresponding to the three rotating elements of the differential mechanism 230 constituting the continuously variable transmission unit 216 are, in order from the left, a g axis representing a rotation speed of the sun gear S0 corresponding to the second rotating element RE2, an e axis representing a rotation speed of the carrier CA0 corresponding to the first rotating element RE1, and an m axis representing a rotation speed of the ring gear R0 corresponding to the third rotating element RE3 (that is, input rotation speed of the stepped transmission unit 218). In addition, four vertical lines Y4, Y5, Y6, Y7 of the stepped transmission unit 218 are, in order from the left, a rotation speed of the sun gear S2 corresponding to the fourth rotating element RE4, a rotation speed of the interconnected ring gear R1 and the carrier CA2 corresponding to the fifth rotating element RES (that is, the rotation speed of the output shaft 220), a rotation speed of the interconnected carrier CA1 and the ring gear R2 corresponding to the sixth rotating element RE6, and an axis representing a rotation speed of the sun gear S1 corresponding to the seventh rotating element RE7. The intervals among the vertical lines Y1, Y2, Y3 are determined according to the gear ratio p0 of the differential mechanism 230. Further, intervals among the vertical lines Y4, Y5, Y6, Y7 are determined according to the gear ratios p1, p2 of the first and second planetary gear devices 232, 234.

When expressed by using the alignment chart of FIG. 13, in the differential mechanism 230 of the continuously variable transmission unit 216, a configuration is provided in which the rotation of the engine 202 is transmitted to the stepped transmission unit 218 through the intermediate transmission member 228 by connecting the engine 202 (see “ENG” in the figure) to the first rotating element RE1 to transmit power, connecting the first rotating machine MG1 (see “MG1” in the figure) to the second rotating element RE2 to transmit power, and connecting the second rotating machine MG2 (see “MG2” in the figure) to a third rotating element RE3 that rotates integrally with an intermediate transmission member 228 connected to the drive wheels 206 to transmit power. In the continuously variable transmission unit 216, the relationship between the rotation speed of the sun gear S0 and the rotation speed of the ring gear RO is indicated by each of straight lines L0e, L0m, and L0R crossing the vertical line Y2.

In addition, in the stepped transmission unit 218, the fourth rotating element RE4 is selectively connected to the intermediate transmission member 228 through the clutch C1, the fifth rotating element RES is connected to the output shaft 220, and the sixth rotating element RE6 is selectively connected to the intermediate transmission member 228 through the clutch C2 and is selectively connected to the case 214 through the brake B2, and the seventh rotating element RE7 is selectively connected to the case 214 through the brake B1. In the stepped transmission unit 218, the rotation speed of each of “1st”, “2nd”, “3rd”, “4th”, “Rev” on the output shaft 220 is shown by each of the straight lines L1, L2, L3, L4, LR crossing the vertical line Y5 by the engagement/release control of the engagement device CB.

The straight line L0e and straight lines L1, L2, L3, L4 indicated by solid lines in FIG. 13 indicate relative speeds of respective rotating elements in forward traveling in a hybrid traveling mode that allows hybrid traveling in which at least the engine 202 is used as a power source is performed. The straight line L0m indicated by a dashed line in FIG. 13 and straight lines L1, L2, L3, L4 indicated by solid lines in FIG. 13 indicate relative speeds of respective rotating elements in forward traveling in a motor traveling mode that allows motor traveling in which at least one of the first rotating machine MG1 and the second rotating machine MG2 are used as a power source, in a state where the operation of the engine 202 is stopped. The straight line L0R and the straight line LR, which are indicated by dashed lines in FIG. 13, indicate the relative speeds of the rotating elements in the reverse traveling in the motor traveling mode.

The vehicle 200 further includes an electronic control unit 240 as a controller including a control device of the vehicle 200 related to control of the engine 202, the first rotating machine MG1, the second rotating machine MG2, and the like. The electronic control unit 240 has the same configuration as the electronic control unit 100 shown in the above first embodiment. Various signals and the like, which are similar to those supplied to the electronic control unit 100, are supplied to the electronic control unit 240. From the electronic control unit 240, various command signals, which are similar to those output by the electronic control unit 100, are output. The electronic control unit 240 has functions equivalent to the respective functions of the hybrid controller 102 and the state determination unit 104 included in the electronic control unit 100. The electronic control unit 240 can implement a control function for improving the rising response of the turbocharging pressure Pchg while suppressing the deterioration of energy efficiency in the vehicle 200 when the engine 202 is started, similarly with that implemented by the electronic control unit 100 as described in the first embodiment.

Here, since the vehicle 200 is provided with the stepped transmission unit 218, the electronic control unit 240 includes a transmission unit, that is, a shift controller 242 that determines the shift of the stepped transmission unit 218 by using, for example, an AT gear stage shift map that is a predetermined relationship and performs shift control of the stepped transmission unit 218 as necessary. In the shift control of the stepped transmission unit 218, the shift controller 242 outputs, to the hydraulic control circuit 236, a hydraulic control command signal Sat for switching the engagement/release state of the engagement device CB by solenoid valves SL1 to SL4 such that the AT gear stage of the stepped transmission unit 218 is automatically switched.

The stepped transmission unit 218 is provided in series on the rear side of the continuously variable transmission unit 216. Therefore, as the AT gear stage of the stepped transmission unit 218 becomes lower at a certain vehicle speed V, the rotation speed of the ring gear RO, which is the output rotation speed of the continuously variable transmission unit 216, is increased, and the engine speed Ne, which can be maintained in a region where the MG1 cranking torque Tgcr can be output in a state where the first rotating machine MG1 is in the negative rotation, that is, in an electric power generation region where the first rotating machine MG1 is in an electric power generation state, is increased. That is, as the AT gear stage of the stepped transmission unit 218 is lower, a wider electric power generation region can be secured when the first rotating machine MG1 cranks the engine 202. In order to effectively use what is mentioned above, when the engine 202 is started where the engine speed Ne is increased by the first rotating machine MG1, the shift controller 242 downshifts the stepped transmission unit 218 when the request engine power Pedem is the output that needs the turbocharging pressure Pchg.

In particular, the shift controller 242 downshifts the stepped transmission unit 218 when the electronic control unit 240 determines that cranking by the first rotating machine MG1 cannot be performed in the electric power generation region of the first rotating machine MG1. In this way, when the engine speed Ne is increased to the cranking speed Net' when turbocharging is needed, the cranking by the first rotating machine MG1 is easily performed in the electric power generation region.

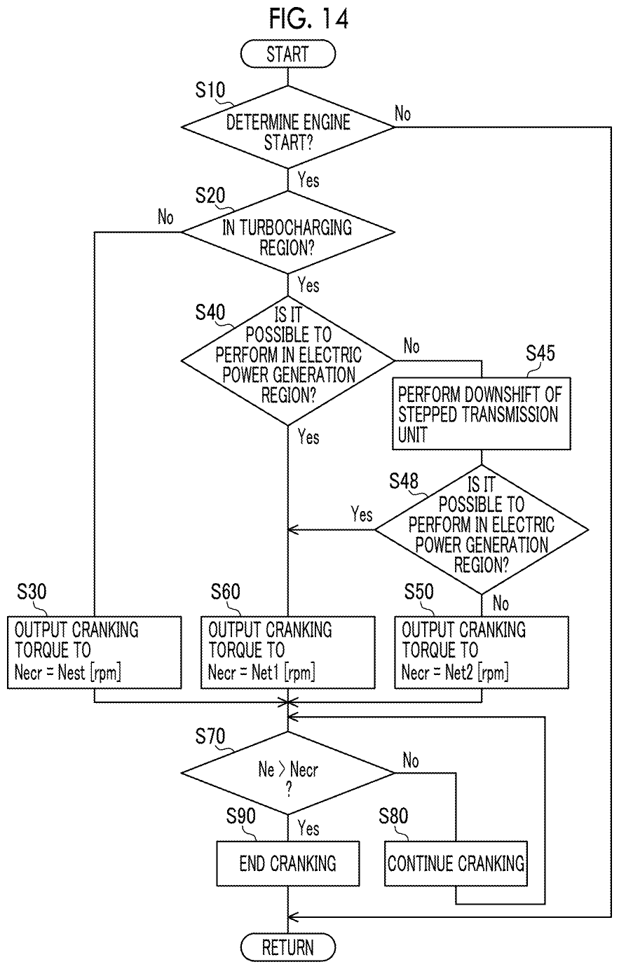

FIG. 14 is a flowchart illustrating a main part of a control operation of the electronic control unit 240, that is, a control operation for improving rising response of the turbocharging pressure Pchg while suppressing deterioration of energy efficiency in the vehicle 200 at the time of starting the engine 202, which is repeatedly executed. The flowchart of FIG. 14 is another embodiment different from the flowchart of FIG. 9.

In FIG. 14, first, S10 to S40 are executed in the same manner as in the flowchart of FIG. 9 in the first embodiment. When the determination in S40 is negative, in

S45 corresponding to the function of the shift controller 242, the downshift of the stepped transmission unit 218 is performed. Next, in S48 corresponding to the function of the state determination unit that the electronic control unit 240 functionally has, when the engine speed Ne is increased to the cranking speed Net1 when turbocharging is needed in the state after the downshift of the stepped transmission unit 218, determination is made whether or not cranking by the first rotating machine MG1 can be performed in the electric power generation region of the first rotating machine MG1. When the determination in S48 is negative, S50 in the flowchart of FIG. 9 is executed. When the determination in S40 is affirmative, or when the determination in S48 is affirmative, S60 in the flowchart of FIG. 9 is executed. Subsequent to S30, or subsequent to S50, or subsequent to S60, S70 and subsequent steps are executed in the same manner as in the flowchart of FIG. 9.

According to the embodiment, the same effects as in the above first embodiment can be obtained. Further, according to the embodiment, when the engine 202 is started where the engine speed Ne is increased by the first rotating machine MG1, the stepped transmission unit 218 is downshifted when the request engine power Pedem is the output that needs the turbocharging pressure Pchg. In this way, the target cranking speed Necr is easily set to a high value while the first rotating machine MG1 is maintained at the negative rotation.

Although the embodiments of the disclosure have been described in detail with reference to the drawings, the disclosure is applicable to other modes.

For example, in the first embodiment described above, the vehicle 10 may be a vehicle in which the transmission unit 58 is not provided and the engine 12 is connected to the differential unit 60, like the vehicle 200. The differential unit 60 may be a mechanism capable of limiting a differential operation by controlling a clutch or a brake connected to a rotating element of the second planetary gear mechanism 82. The second planetary gear mechanism 82 may be a double pinion type planetary gear device. Further, the second planetary gear mechanism 82 may be a differential mechanism in which a plurality of planetary gear devices is connected to each other to have four or more rotating elements. The second planetary gear mechanism 82 may be a differential gear device in which the first rotating machine MG1 and the drive gear 74 are respectively connected to a pinion that is driven to rotate by the engine 12 and a pair of bevel gears that mesh with the pinion. The second planetary gear mechanism 82 may be a mechanism which has a configuration in which two or more planetary gear devices are connected to each other by some of the rotating elements constituting the planetary gear mechanisms, and the engine, the rotating machine, and the drive wheels are connected to the rotating elements of the planetary gear devices to transmit power.

Further, in the above-described second embodiment, the one-way clutch F0 is exemplified as the lock mechanism capable of fixing the carrier CA0 in a non-rotatable state, but the disclosure is not limited to this mode. This lock mechanism may be an engagement device such as a meshing type clutch, a hydraulic friction engagement device such as a clutch and a brake, a dry engagement device, an electromagnetic friction engagement device, a magnetic powder clutch, for example, for selectively connecting the connection shaft 226 and the case 214. Alternatively, the vehicle 200 does not necessarily need to include the one-way clutch F0.

Further, in the above-described second embodiment, the stepped transmission unit 218 is exemplified as the automatic transmission that forms a part of the power transmission path between the differential mechanism 230 and the drive wheels 206, but the disclosure is not limited to this mode. The automatic transmission may be, for example, a synchronous mesh-type parallel two-shaft automatic transmission, a well-known dual clutch transmission (DCT) that is the synchronous meshing parallel two-shaft type automatic transmission and has two systems of input shafts, and a well-known belt-type continuously variable transmission.

Further, in the above-described embodiments, a mechanical pump type turbocharger that is driven to rotate by an engine or an electric motor may be provided in addition to or instead of the exhaust turbine type turbocharger 18. Alternatively, the turbocharger 18 may include an actuator capable of controlling the rotation speed of the compressor 18c, for example, an electric motor.

It should be noted that the above description is merely an embodiment, and that the present disclosure can be implemented in various modified and improved forms based on the knowledge of those skilled in the art.

What is claimed is:

1. A control device for a hybrid vehicle including an engine with a turbocharger, a first rotating machine, an electric transmission mechanism, and a second rotating machine, the electric transmission mechanism having a differential mechanism splitting power of the engine to transmit the split power to drive wheels and the first rotating machine and controlling a differential state of the differential mechanism by controlling an operating state of the first rotating machine, the second rotating machine being connected to the drive wheels to transmit power, the control device comprising:
an engine start controller configured to control an output torque of the first rotating machine to apply a torque for increasing an engine speed of the engine to the engine and bring the engine into an operating state, when the engine during rotation stop is started,
wherein the engine start controller is configured to,
when the engine is started, set a target engine speed at a time of increasing the engine speed by the first rotating machine to a value at which the first rotating machine is maintained in an electric power generation state when a request output for the engine is an output that needs a turbocharging pressure by the turbocharger, the value being higher than when the request output is not the output that needs the turbocharging pressure, and
even after the engine is brought into the operating state, control the output torque of the first rotating machine to apply a torque for increasing the engine speed to the target engine speed to the engine.

2. The control device according to claim 1, further comprising:
a torque assist controller configured to output a part of a drive torque from the second rotating machine by using electric power generated by the first rotating machine in the electric power generation state, when the engine is started where the engine speed is increased by the first rotating machine.

3. The control device according to claim 1, wherein the engine start controller is configured to set the target engine speed at the time of increasing the engine speed by the first rotating machine to a predetermined engine speed at which fuel supply to the engine is started to start operation of the engine, when the request output is not the output that needs the turbocharging pressure.

4. The control device according to claim 1, wherein:
the differential mechanism includes a first rotating element to which the engine is connected to transmit power, a second rotating element to which the first rotating machine is connected to transmit power, and a third rotating element that is connected to the drive wheels to transmit power, and the second rotating element, the first rotating element, and the third rotating element are arranged in order from a first end toward a second end on an alignment chart that relatively represents rotation speeds of respective rotating elements;
the engine start controller is configured to, when the engine is started, apply the torque for increasing the engine speed to the engine by applying, to the engine, a torque for rotating the engine in a positive rotation direction that is a rotation direction when the engine is in the operating state; and
the engine start controller is configured to, when the engine is started, control the output torque of the first rotating machine in the electric power generation state of the first rotating machine by controlling the output torque of the first rotating machine in a state where the first rotating machine is in a negative rotation.

5. The control device according to claim 4, wherein the engine start controller is configured to, when the engine is started, set the target engine speed to be a higher value as a vehicle speed increases, when the request output for the engine is the output that needs the turbocharging pressure.

6. The control device according to claim 4, wherein:
the hybrid vehicle further includes a mechanical transmission mechanism constituting a part of a power transmission path between the electric transmission mechanism and the drive wheels; and
the control device further comprises a shift controller configured to, when the engine is started where the engine speed is increased by the first rotating machine, downshift the mechanical transmission mechanism when the request output for the engine is the output that needs the turbocharging pressure.
